(19) United States
(12) Patent Application Publication
(10) Pub. No.: US 2025/0252716 A1
(43) Pub. Date: Aug. 7, 2025

(54) SYSTEMS AND METHODS FOR LARGE-SCALE BENCHMARKING AND BOOSTING TRANSFER LEARNING FOR MEDICAL IMAGE ANALYSIS

(71) Applicants: Mohammad Reza Hosseinzadeh Taher, Tempe, AZ (US); Fatemeh Haghighi, Tempe, AZ (US); Jianming Liang, Scottsdale, AZ (US)

(72) Inventors: Mohammad Reza Hosseinzadeh Taher, Tempe, AZ (US); Fatemeh Haghighi, Tempe, AZ (US); Jianming Liang, Scottsdale, AZ (US)

(73) Assignee: Arizona Board of Regents on Behalf of Arizona State University, Tempe, AZ (US)

(21) Appl. No.: 19/046,367

(22) Filed: Feb. 5, 2025

Related U.S. Application Data
(60) Provisional application No. 63/549,812, filed on Feb. 5, 2024.

(51) Int. Cl. G06V 10/774; G06T 7/00; G06V 10/776; G06V 10/82

(52) U.S. Cl. CPC G06V 10/774; G06T 7/0012; G06V 10/776; G06V 10/82; G06T 2207/20081; G06T 2207/20084; G06T 2207/30004; G06V 2201/03

(57) ABSTRACT

A model pretrained on photographic images is fine-tuned via domain-adaptive pretraining to accommodate transfer learning for medical image analysis. The model can include fine-grained representations for fine grained medical tasks and is self-supervised. The model can be configured via domain-adaptive pretraining and enhanced via utilization of expert notations associated with medical datasets such that the model is performant and yields increased transferability for medical tasks.

### CROSS REFERENCE TO RELATED APPLICATIONS

This is a non-provisional application that claims benefit to U.S. Provisional Application Ser. No. 63/549,812, filed on Feb. 5, 2024, which is herein incorporated by reference in its entirety.

### GOVERNMENT SUPPORT

This invention was made with government support under R01 HL128785 awarded by the National Institutes of Health. The government has certain rights in the invention.

### FIELD

The present disclosure generally relates to medical image analysis and machine learning models; and in particular to systems and methods for large-scaled benchmarking and boosting transfer learning for medical image analysis.

### BACKGROUND

The recent past has witnessed the emergence of numerous models of distinct architectures pretrained on various datasets with different strategies. However, the lack of a comprehensive evaluation assessing the transferability of these models to medical tasks poses challenges for practitioners in selecting the most suitable pretrained models in medical imaging, leaving several critical questions unanswered.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is an illustration of different models as described herein showing specifically fine-tuning of various ImageNet pretrained models with popular network architectures yields superior performance over training the target models from random initialization for a diverse set of medical applications, underscoring the importance of transfer learning in medical imaging.

FIG. 2 is an illustration of comparison of transfer learning from supervised ImageNet models across conventional and modern ConvNet and vision transformer architectures.

FIG. 3 is an illustration of comparison of training target models with different architectures from random initialization.

FIG. 4 is a series of illustrations detailing that fine-tuning data size plays an important role in bridging the performance gap between ConvNets and vision transformers in medical imaging tasks.

FIG. 5 is an illustration of the size of the training dataset as it impacts ConvNet and vision transformer models in both training from scratch and transfer learning settings.

FIG. 6 is a series of graphs illustrating fine-tuning of models pretrained on large-scale finer grained datasets.

FIG. 7 is a series of graphs showing self-supervised learners can capture holistic features more effectively than supervised counterparts.

FIG. 8 is a series of graphs showing domain-adaptive pretraining serves as a vital bridge between the photographic and medical imaging domains, leading to improved performances compared with the standard ImageNet pretraining in all target tasks.

FIG. 9 is a series of graphs illustrating domain-adaptive pretraining can boost the performance of ImageNet models with modern ConvNet and vision transformer backbones.

FIG. 10 is a series of graphs illustrating that fine-tuning ImageNet pretrained models remains a valuable resource for fostering high-performance models in medical imaging.

FIG. 11 is a series of graphs illustrating self-supervised learning using medical images holds the potential to yield more generalizable representations than those acquired through in-domain supervised learning.

FIG. 12 is an illustration of the self-supervised LVM-Med pretrained model that demonstrates superior transfer performance across various target tasks compared with the full-supervised RadImageNet pretrained model.

FIG. 13 is an example process flow or method directed to functionality described herein.

FIG. 14 is a simplified illustration of a computing device that can be implemented for functionality described herein.

Corresponding reference characters indicate corresponding elements among the view of the drawings. The headings used in the figures do not limit the scope of the claims.

### DETAILED DESCRIPTION

Transfer learning, particularly fine-tuning models pretrained on photographic images to medical images, has proven indispensable for medical image analysis. There are numerous models with distinct architectures pretrained on various datasets using different strategies. But, there is a lack of up-to-date large-scale evaluations of their transferability to medical imaging, posing a challenge for practitioners in selecting the most proper pretrained models for their tasks at hand. To fill this gap, the present disclosure describes a systematic study, focusing on (i) benchmarking numerous conventional and modern convolutional neural network (ConvNet) and vision transformer architectures across various medical tasks; (ii) investigating the impact of fine-tuning data size on the performance of ConvNets compared with vision transformers in medical imaging; (iii) examining the impact of pretraining data granularity on transfer learning performance; (iv) evaluating transferability of a wide range of recent self-supervised methods with diverse training objectives to a variety of medical tasks across different modalities; and (v) delving into the efficacy of domain-adaptive pretraining on both photographic and medical datasets to develop high-performance models for medical tasks.

The subject large-scale study (˜5,000 experiments) yields impactful insights: (1) ConvNets demonstrate higher transferability than vision transformers when fine-tuning for medical tasks; (2) ConvNets prove to be more annotation efficient than vision transformers when fine-tung for medical tasks; (3) Fine-grained representations, rather than high-level semantic features, prove pivotal for fine-graine medical tasks; (4) Self-supervised models excel in learning holistic features compared with supervised models; and (5) Domain-adaptive pretraining leads to performant models via harnessing knowledge acquired from ImageNet and enhancing it through the utilization of readily accessible expert annotations associated with medical datasets.

### 1. Introduction

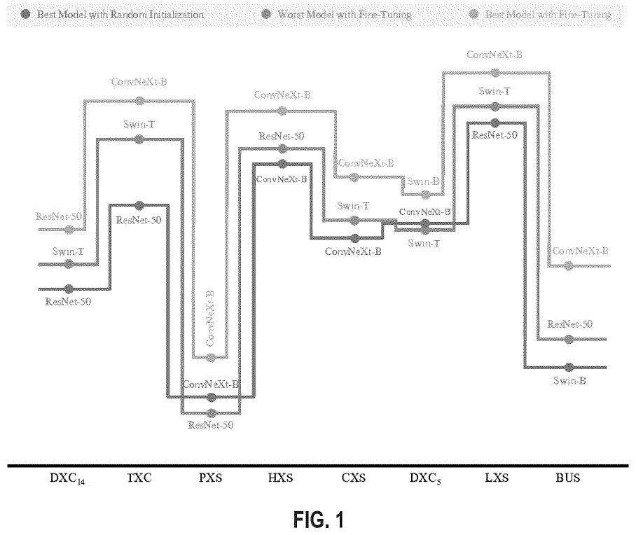

Fine-tuning models pretrained on large-scale photographic datasets (e.g. ImageNet) to medical images (Tajbakhsh et al., 2016; Shin et al., 2016; Matsoukas et al., 2022) remains the de-facto approach for circumventing the challenge of annotation scarcity in medical imaging (Tajbakhsh et al., 2021). This dominance will continue in the foreseeable future, even with the rise of exploring alternative pretraining methods using medical data (Zhou et al., 2019; Haghighi et al., 2021; Ghesu et al., 2022; Mei et al., 2022), largely due to the two reasons: First, photographic pretrained models—specifically supervised ImageNet models—for various backbones are readily accessible (Horn et al., 2021), offering superior performance over models trained from scratch (see FIG. 1). Second, owing to the diversity in shapes, textures, and colors inherent in photographic images—as opposed to the often visually homogeneous medical images—ImageNet models can acquire diverse visual representations, which are vital for effectively identifying different object of interests (i.e., lesions or organs) in medical applications (Geirhos et al., 2019; Matsoukas et al., 2022). As evidenced by (Zhou et al., 2021b; Ke et al., 2021; Ali et al., 2022), a substantial portion of top-performing medical models across diverse applications, including identification of thoracic diseases, pulmonary embolism, skin cancer, and Alzheimer's disease, are fine-tuned from supervised ImageNet models.

The recent past has witnessed the emergence of numerous models of distinct architectures pretrained on various datasets with different strategies. However, the lack of a comprehensive evaluation assessing the transferability of these models to medical tasks poses challenges for practitioners in selecting the most suitable pretrained models in medical imaging, leaving several critical questions unanswered. As such, we conduct a large-scale empirical investigation (˜5,000 experiments) in the context of transfer learning for medical vision tasks, designing a series of systematic experiments to explore our research questions and contributions as follows:

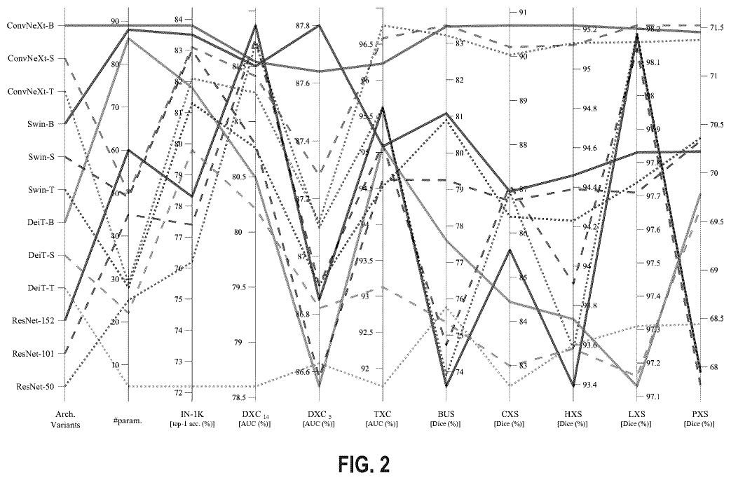

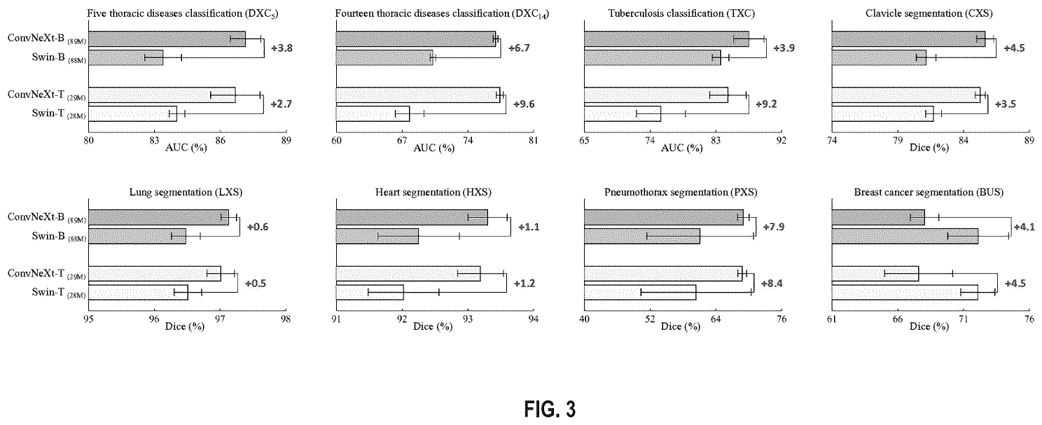

Question 1: Are pretrained ConvNets or vision transformers more transferable to medical imaging tasks? The debates about the superiority between vision transformers and convolutional neural networks (ConvNets) in computer vision recently leans towards vision transformers as viable alternatives to ConvNets (Xiao et al., 2023). However, the lack of a broad study to compare efficacy of vision transformers and ConvNets in medical vision leaves us wondering whether we could trivially switch to vision transformers. To bridge this gap, we conduct an extensive study (˜1,400 experiments) to benchmark numerous conventional and modern ConvNet and vision transformer architectures on various medical tasks. Our findings reveal that ConvNeXt (Liu et al., 2022)—a modernized ConvNet model—not only surpasses traditional ConvNets but also outperforms state-of-the-art (SOTA) vision transformers like Swin (Liu et al., 2021) in a diverse set of medical tasks, emphasizing the continued relevance and effectiveness of ConvNets in medical imaging (see Sec. 3.1, FIG. 2, and FIG. 3).

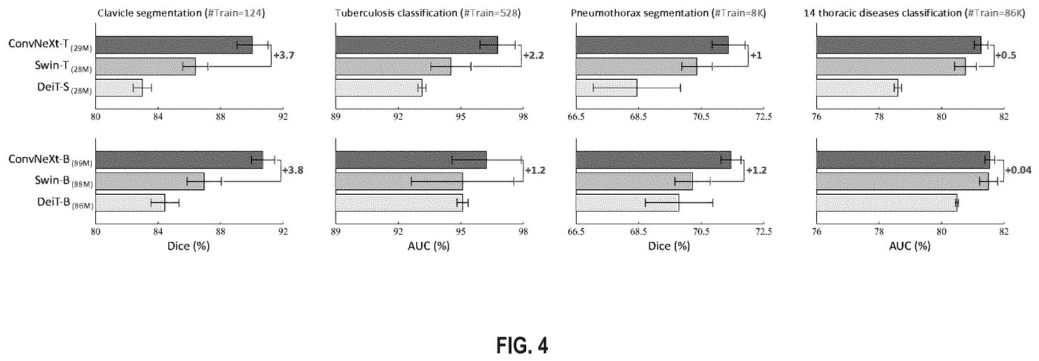

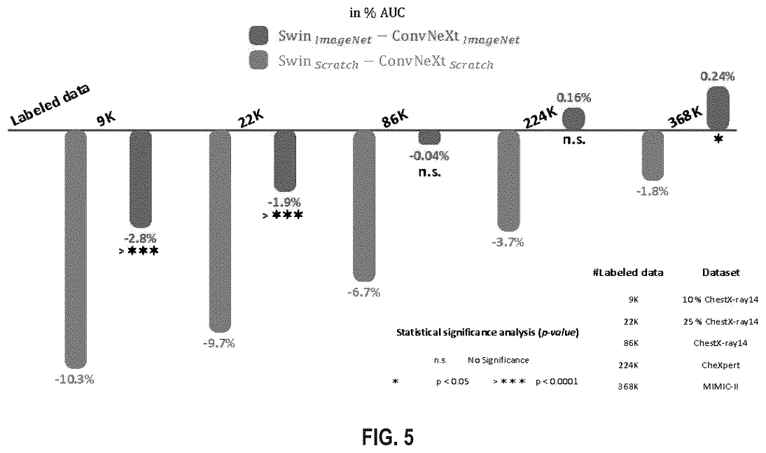

Question 2: Are pretrained ConvNets or vision transformers more annotation efficient for medical imaging tasks? Pretrained vision transformers have recently showcased superior performance compared with their ConvNet counterparts in some medical applications, particularly when fine-tuned with abundant labeled data (Matsoukas et al., 2021; Xiao et al., 2023). However, the lack of a comprehensive and up-to-date benchmark to dissect the behavior of pretrained ConvNets and vision transformers across various medical applications with different amounts of fine-tuning data (ranging from small to large), leaves a gap in understanding their transfer learning efficacy, especially in medical imaging tasks with a dearth of annotated data. To bridge this gap, we conduct a systematic study (˜400 experiments) to investigate the impact of fine-tuning data size (ranging from 100 to 368,000 samples) on the performance of vision transformers compared with ConvNets in medical imaging. Our findings reveal that ConvNets are more annotation efficient than transformers when fine-tuned for medical tasks, while also highlight that vision transformers have potential to favorably compete with ConvNets, particularly when substantial data is available (see Sec. 3.2, FIG. 4, and FIG. 5).

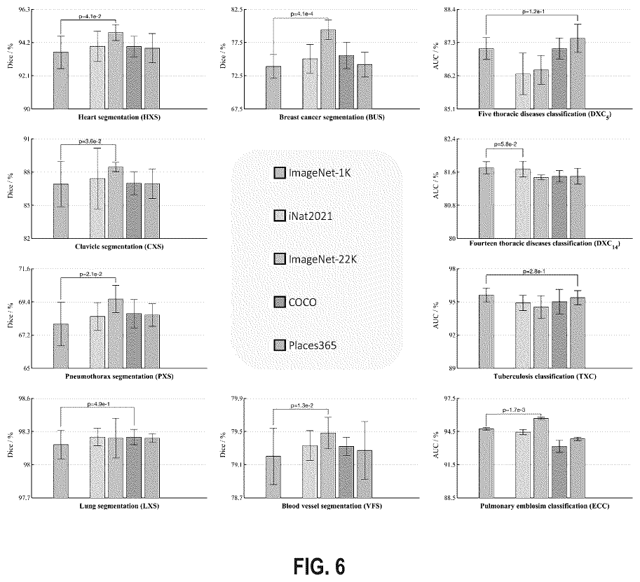

Question 3: What advantages can fine-grained data offer for pretraining models in transfer learning for medical imaging compared with coarse-grained data? The existing medical imaging literature mostly focuses on pretrained models using the ImageNet-1K dataset which was created for coarse-grained object classification (Mustafa et al., 2021; Azizi et al., 2021; Matsoukas et al., 2022). However, the potential advantages of utilizing pretrained models with large-scale fine-grained datasets for transfer learning in medical imaging remains largely unexplored. To bridge this gap, we conduct an extensive study (˜500 experiments) to assess the effectiveness of four fine-grained datasets—iNat2021 (Horn et al., 2021), ImageNet-22K (Ridnik et al., 2021), Places365 (Zhou et al., 2017), and COCO (Lin et al., 2014) (see Table 1)—as pretraining sources for myriad medical imaging tasks. Our findings reveal that pretrained models on datasets with finer data granularity and greater diversity yield more distinctive local representations, crucial for medical imaging tasks that are reliant on recognition of small, local variations in texture to detect/segment lesions and organs (see Sec. 3.3 and FIG. 6).

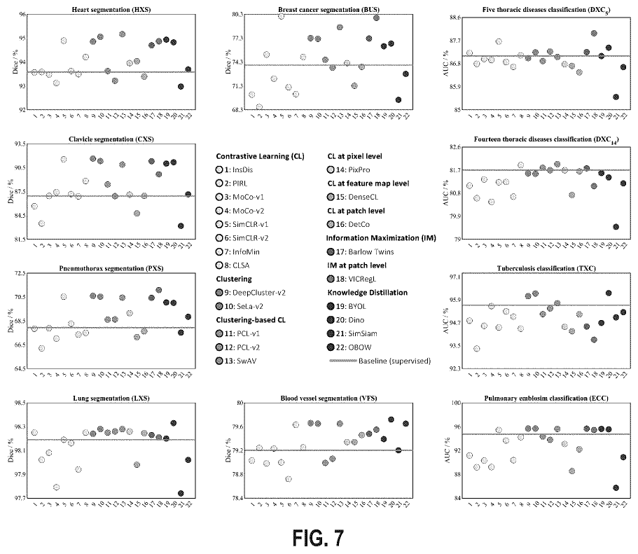

Question 4: How generalizable are the self-supervised ImageNet models to medical imaging tasks compared with supervised ImageNet models? The ongoing rapid advancements in self-supervised learning (SSL) have led to the development of newly-established self-supervised ImageNet models that outperform gold standard supervised ImageNet models in various computer vision tasks (Caron et al., 2020a; Ericsson et al., 2021; Zhao et al., 2021; Caron et al., 2021; Xie et al., 2021b). Despite the public availability of a plethora of SOTA self-supervised ImageNet models, there is a lack of a large-scale, up-to-date evaluation of these models when applied to diverse medical imaging tasks. To bridge this gap, we carry out an in-depth benchmark (˜2,000 experiments) to evaluate the efficacy of 22 recent self-supervised methods with diverse training objectives (see Table 1) across numerous medical applications with various modalities, including X-ray, Ultrasound, CT, and fundoscopy images. Our findings reveal that self-supervised ImageNet models learn holistic features more effectively than supervised ImageNet models, yielding higher generalizability in medical imaging tasks (see Sec. 3.4 and FIG. 7).

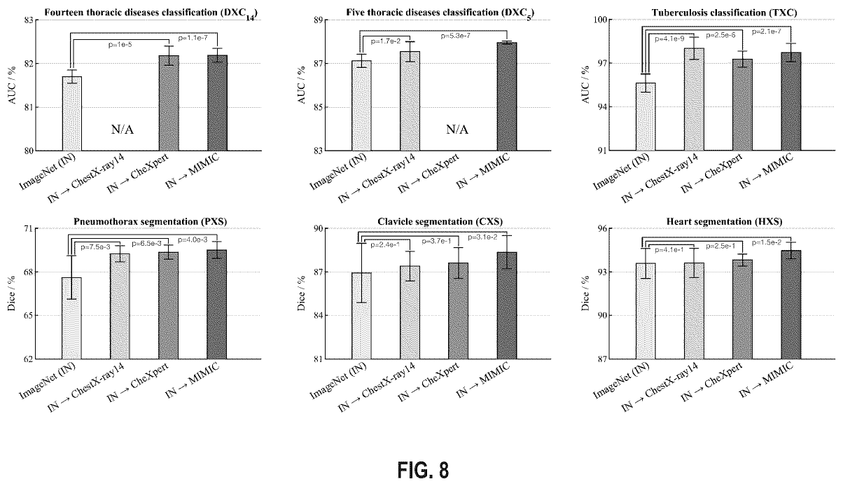

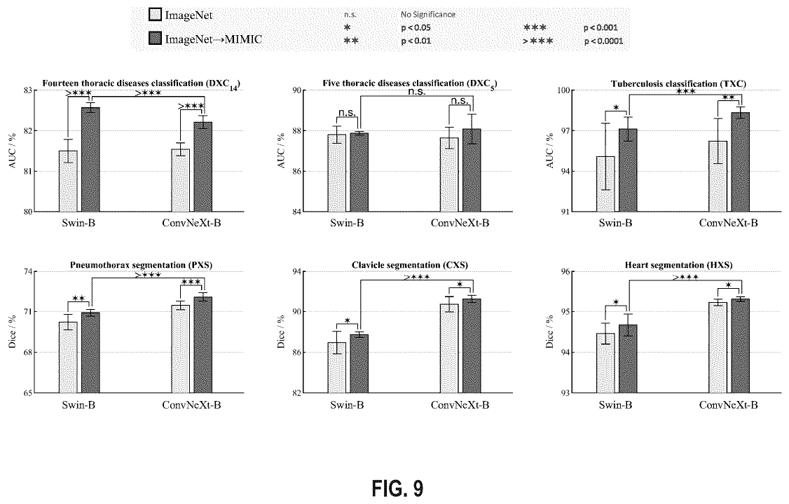

Question 5: How can readily accessible expert annotations associated with medical datasets enhance ImageNet models' capability to capture domain-relevant semantic information? Pretrained ImageNet models serve as the prevailing standard for transfer learning in medical imaging. However, the inherent disparities between photographic and medical images, alongside differences in recognition tasks between ImageNet and medical datasets, hinder ImageNet models from effectively capturing essential semantic features (relevant to diseases and organs) for medical recognition tasks (Raghu et al., 2019; Azizi et al., 2021; Mei et al., 2022). This constraint motivates us to present a practical approach that tailors ImageNet models to medical applications. Towards this end, we delved into the effectiveness of domain-adaptive pretraining—originally developed in natural language processing (Pan and Yang, 2010; Glorot et al., 2011)—on both photographic and medical datasets. We develop various domain-adapted models using SOTA vision transformer and ConvNet architectures and extensively evaluate them in a wide range of medical imaging tasks (˜400 experiments). Our findings reveal that our domain-adapted models harness knowledge acquired from ImageNet and enhance it by incorporating readily conducted annotation efforts derived from medical datasets, leading to the development of more performant models (see Sec. 3.5, FIG. 8, and FIG. 9).

The present disclosure is organized as follows. Section 2 begins by delineating the described transfer learning setup, focusing on downstream tasks and datasets (Sec. 2.1), pretrained models (Sec. 2.2), and fine-tuning settings and evaluations (Sec. 2.3). Subsequently, in Sec. 3, the motivation is delved into, including a discussion of related works, experimental setup, observations, and analysis corresponding to each of the aforementioned research questions in distinct subsections: Sec. 3.1 (Question 1), Sec. 3.2 (Question 2), Sec. 3.3 (Question 3), Sec. 3.4 (Question 4), and Sec. 3.5 (Question 5). In Sec. 4, an extensive discussion is presented that not only encapsulates the core findings from Questions 1 to 5 but also extends the analysis to broader aspects of transfer learning in medical image analysis. Specifically, the following is delved into: (i) assessing the efficacy of pretraining with the RadImageNet dataset compared with the ImageNet dataset (Sec. 4.1). (ii) investigating the effectiveness of in-domain self-supervised learning compared with in-domain supervised learning (Sec. 4.2). (iii) exploring the transferability of self-supervised pretrained models using in-domain versus out-domain data (Sec. 4.3). (iv) evaluating the robustness of pretrained ConvNets and vision transformers under stress testing (Sec. 4.4). (v) examining the transferability of convolution-transformer hybrid pretrained models (Sec. 4.5). (vi) conducting ablation studies on different segmentation architectures (Sec. 4.6). (vii) investigating the impact of pretext task design and data granularity on the transferability of self-supervised learning models (Sec. 4.7). (viii) discussing the trade-off between high-performance but computationally intensive vision transformer and ConvNet models (Sec. 4.8). (ix) discussing the practical utility of the subject findings for clinical settings (Sec. 4.9). And, (x) outlining the scope of the described study and directions for future work (Sec. 4.10).

### 2. Transfer Learning Setup

### 2.1. Downstream Tasks and Datasets

Table 1 summarizes the tasks and datasets. The study presented considers a wide range of 14 challenging downstream tasks on publicly available datasets, including breast ultrasound images (BUSI) (Al-Dhabyani et al., 2020), SCR-Clavicle (van Ginneken et al., 2006), CheXpert (Irvin et al., 2019), VinDR-CXR (Nguyen and et al., 2020), MIMIC-CXR (Johnson et al., 2019), NIH ChestX-ray14 (Wang et al., 2017), ChestX-Det (Lian et al., 2021), PE RSNA (Colak et al., 2021), SCR-Heart (van Ginneken et al., 2006), NIH Montgomery (Jaeger et al., 2014), SIIM-ACR (Zawacki et al., 2019), VinDr-Rib (Nguyen et al., 2021), NIH Shenzhen CXR (Jaeger et al., 2014), and DRIVE (Budai et al., 2013). These tasks contain numerous hallmark challenges encountered when working with medical images, such as imbalanced classes, limited data, and small-scanning areas for the pathology of interest. To ensure a comprehensive evaluation, we set up our experiments to assess each pretrained model under varying challenging tasks (classification and segmentation), object definitions (e.g., lesion and anatomical structures), and modalities (X-ray, CT, Ultrasound, and Fundoscopic). When available, we use the official data split of the datasets; otherwise, we randomly divide the data into 80%/20% for training/testing. More detailed information can be found in the Appendix A.

### 2.2. Pretrained Models

We conduct a large-scale study to evaluate the effectiveness of a diverse range of 53 pretrained models for transfer learning to medical applications, including (i) 12 supervised models pretrained on ImageNet-1K dataset with different variants of standard and modern ConvNet and vision transformer backbone families, encompassing ResNet-{50,101,152} variants from the ResNet (He et al., 2016) family, ConvNext-{T,S,B} variants from the ConvNext (Liu et al., 2022) family, DeiT-{T,S,B} from the DeiT (Touvron et al., 2021) family, and Swin-{T,S,B} from the Swin transformer (Liu et al., 2021) family; (ii) 5 supervised models pretrained on large-scale and fine-grained photographic datasets, including ImageNet-1K, iNat2021 (Horn et al., 2021), ImageNet-22K (Ridnik et al., 2021), COCO (Lin et al., 2014), and Places365 (Zhou et al., 2017); (iii) 22 self-supervised models with diverse training objectives pretrained on ImageNet-1K dataset; (iv) 5 domain-adapted models pre-trained on ImageNet-1K followed by in-domain datasets, including ChestX-ray14, CheXpert, and MIMIC-CXR, with different ConvNet and vision transformer backbones; (v) 2 large-scale medical models pretrained on 1.3 million medical images, including supervised RadImageNet model (Mei et al., 2022) and self-supervised LVM-Med model (Nguyen et al., 2023); and (vi) 7 self-supervised models pretrained on in-domain ChestX-ray14 dataset. We pretrain domain-adapted and in-domain self-supervised models, and for all other supervised and self-supervised pretraining methods, we use existing official and ready-to-use pretrained models, ensuring that their configurations have been meticulously assembled to achieve the best results in the target tasks.

TABLE 1
Pretraining and target tasks and datasets. We evaluate a broad spectrum of models pretrained on large-
scale general and in-domain datasets for 14 medical imaging tasks, covering different label structures
(binary classification, multi-label classification, and segmentation), modalities (X-ray, CT, Fundoscopic,
and Ultrasound), organs (lung, heart, clavicle, ribs, eye, and breast), diseases, and data size.
In the target tasks' code, the first letter denotes the object of interest (“B” for breast
cancer, “C” for clavicle, “E” for embolism, “D” for thoracic diseases, etc.);
the second letter denotes the modality (“X” for X-ray, “F” for Fundoscopic, “C”
for CT, and “U” for ultrasound); the last letter denotes the task (“C” for classification,
“S” for segmentation). “IN” denotes ImageNet.

| Supervised Pretrained Model (Task) | Dataset | #Images | #Classes |
|---|---|---|---|
| ImageNet-1K (Image classification) | ImageNet (Russakovsky et al., 2015) | 1.3M | 1K |
| iNat21 (Natural world image classification) | iNaturalist 2021 (Hornet al., 2021) | 2.5M | 10K |
| ImageNet-22K (Image classification) | ImageNet (Ridnik et al., 2021) | 14M | 22K |
| COCO (Instance segmentation) | Microsoft COCO (Lin et al., 2014) | 328K | 91 |
| Places365 (Scene image classification) | Places365 (Zhou et al., 2017) | 1.8M | 365 |
| IN-*ChestX-ray14 (Thoracic diseases classification) | ChestX-ray14 (Wang et al., 2017) | 86K | 14 |
| IN-*CheXpert (Thoracic diseases classification) | CheXpert (Irvin et al., 2019) | 224K | 14 |
| IN-*MIMIC (Thoracic diseases classification) | MIMIC-CXR (Johnson et al., 2019) | 368K | 13 |
| RadImageNet (Diseases classification) | RadImageNet (Mei et al., 2022) | 1.3M | 165 |

| Self-supervised Pretrained Model | | |
|---|---|---|
| InsDis (Wu et al., 2018) | PIRL (Misra and Maaten, 2020) | BYOL (Grill et al., 2020) |
| MoCo-v2 (Chen et al., 2020c) | SimCLR-v1 (Chen et al., 2020a) | DINO (Caron et al., 2021) |
| InfoMin (Tian et al., 2020) | CLSA (Wang and Qi, 2023) | SimSiam (Chen and He, 2021) |
| PCL-v1 (Li et al., 2021) | PCL-v2 (Li et al., 2021) | OBVW (Gidaris et al., 2021) |
| MoCo-v1 (He et al., 2020) | SimCLR-v2 (Chen et al., 2020b) | PixPro (Xie et al., 2021b) |
| DeepCluster-v2 (Caron et al., 2020b) | SwAV (Caron et al., 2020b) | DenseCL (Wang et al., 2021b) |
| Barlow Twins (Zbontar et al., 2021) | DetCo (Xie et al., 2021a) | VICRegL (Bardes et al., 2022b) |
| SeLa-v2 (Caron et al., 2020b) | TransVW (Haghighi et al., 2021) | PCRL (Zhou et al., 2021a) |
| Adam (Hosseinzadeh Taher et al., 2023) | DiRA (Haghighi et al., 2022) | LVM-Med (Nguyen et al., 2023) |

| Target Task (Code) | Dataset | #Train/Test | #Classes |
|---|---|---|---|
| Breast cancer segmentation (BUS) | BUSI (Al-Dhabyani et al., 2020) | 622/158 | 2 |
| Clavicle segmentation (CXS) | SCR-Clavicle (van Ginneken et al., 2006) | 124/123 | 2 |
| Thoracic diseases classification (DXC₅) | CheXpert (Irvin et al., 2019) | 224K/234 | 5 |
| Thoracic diseases classification (DXC₆) | VinDR-CXR (Nguyen and et al., 2020) | 15K/3K | 6 |
| Thoracic diseases classification (DXC₁₃) | MIMIC-CXR (Johnson et al., 2019) | 368K/5K | 13 |
| Thoracic diseases classification (DXC14) | ChestX-ray14 (Wang et al., 2017) | 86K/25K | 14 |
| Thoracic diseases segmentation (DXS) | ChestX-Det (Lian et al., 2021) | 3K/553 | 13 |
| Pulmonary embolism classification (ECC) | RSNA PE Detection (Colak et al., 2021) | 6K/1K | 2 |
| Heart segmentation (HXS) | SCR-Heart (van Ginneken et al., 2006) | 124/123 | 2 |
| Lung segmentation (LXS) | NIH Montgomery (Jaeger et al., 2014) | 109/29 | 2 |
| Pneumothorax segmentation (PXS) | SIIM-ACR (Zawacki et al., 2019) | AK/2K | 2 |
| Ribs segmentation (RXS) | VinDr-Rib (Nguyen et al., 2021) | 196/49 | 20 |
| Tuberculosis classification (TXC) | Shenzhen CXR (Jaeger et al., 2014) | 528/134 | 2 |
| Retina blood vessels segmentation (VFS) | DRIVE (Budai et al., 2013) | 20/20 | 2 |

### 2.3. Fine-Tuning Settings and Evaluations

We assess numerous models that have been pretrained using various architectures, datasets, and methods for a range of medical imaging tasks, including classification and segmentation. For transfer learning to the classification target tasks, we append a task-specific classification head to the pretrained backbone models under the study. For transfer learning to the segmentation target tasks, we employ a U-Net network (Ronneberger et al., 2015), where the encoder is initialized with the pretrained models and the decoder is randomly initialized. For the ConvNext and Swin backbones, we adhere to their official segmentation networks (Liu et al., 2021, 2022). To assess the quality of the representations learned by each pretrained model, we follow the common protocol (Raghu et al., 2019; Haghighi et al., 2020, 2021; Azizi et al., 2021) and fine-tune all the parameters of the target models. We strive to optimize each target task with the best performing hyperparameters. More detailed information can be found in the Appendix B. For target tasks on X-ray, Fundoscopic, CT, and Ultrasound modalities, we use input resolutions 224×224, 512×512, 576×576, and 224×224, respectively. For all target tasks, we employ standard data augmentation techniques. We employ the early-stop mechanism using 10% of the training data as the validation set to avoid over-fitting. We utilize AUC (area under the ROC curve) and mean Dice coefficient metrics for evaluating the accuracy of the classification and segmentation target tasks, respectively. We run each method ten times on each target task and report the average and standard deviation.

In the present study, a one-tailed Welch's t-test was employed to conduct statistical significance analysis. A one-tailed test was chosen to consider a specific directional hypothesis (i.e., Model A's mean is greater than Model B's mean in a task). Welch's t-test was selected because it does not assume equal variances between groups, making it more robust and reliable in the presence of heteroscedasticity (unequal variances). Additionally, it helps to reduce the potential for Type I errors, as Welch's t-test is more conservative than the standard t-test (Derrick et al., 2016; Ergin and Koskan, 2023).

### 3. Transfer Learning Benchmarking and Analysis

### 3.1. ConvNets are More Transferable than Vision Transformers in Fine-Tuning for Medical Imaging Tasks

The architectural design plays a critical role in determining a model's capacity to capture complex patterns, thereby influencing the quality of the learned visual representations. Given the prominence of ImageNet, the machine learning community has devoted substantial efforts to designing various architectures, aiming to improve performance on ImageNet benchmark (Tuggener et al., 2022; Fang et al., 2023; Woo et al., 2023).

ConvNets and vision transformers, currently, are two main-stream architectures prevalent in solving vision tasks. ConvNets (He et al., 2016; Huang et al., 2017; Tan and Le, 2019; Radosavovic et al., 2020) have been widely used for years, but the emergence of vision transformers (Dosovitskiy et al., 2021; Touvron et al., 2021; Wang et al., 2021a; Yuan et al., 2021; Dehghani et al., 2023) has introduced a transformative shift in the field, demonstrating their superiority over traditional ConvNets in various applications, with notable success in renowned challenges like ImageNet (Zhai et al., 2022). Furthermore, the advent of hierarchical transformers, such as Swin (Liu et al., 2021), which reintroduced ConvNet inductive biases in the original vision transformer design, has further solidified their position as an essential component in modern vision systems. On the other hand, driven by the success of hierarchical transformers, a new family of ConvNet models called ConvNext (Liu et al., 2022) has emerged. ConvNext serves as a compelling reminder that ConvNets are far from obsolete, as it not only surpasses conventional ConvNets but also emerges as a formidable competitor to SOTA vision transformers like Swin across different benchmarks (Liu et al., 2022; Woo et al., 2023).

Despite the competitive success of modern ConvNet and vision transformer models in computer vision, it remains unexplored to what extent their success transfers to the medical vision. To bridge this gap, in contrast to previous studies (Raghu et al., 2019; Ke et al., 2021; Matsoukas et al., 2021; Xiao et al., 2023; Rajaraman et al., 2022) that are limited to one specific application/modality (e.g. tuberculosis classification from chest X-rays (Rajaraman et al., 2022) or thoracic disease classification in chest X-rays (Ke et al., 2021; Matsoukas et al., 2021)) or conventional ConvNet and vision transformer architectures (e.g. ResNet, DenseNet, and ViT families (Raghu et al., 2019; Ke et al., 2021; Matsoukas et al., 2021; Xiao et al., 2023; Rajaraman et al., 2022)), we perform a large-scale empirical study to benchmark transfer learning across conventional and modern vision transformer and ConvNet architectures on various medical imaging tasks.

Experimental setup: We conduct an extensive study of transfer learning across 12 conventional and modern network architectures, including both ConvNets and vision transformers. These network architectures range from 72.20% to 83.8% ImageNet top-1 accuracy, and encompass the variants of widely used ResNet architectures, as well as SOTA ConvNet (i.e. ConvNext) and vision transformers (i.e., DeiT and Swin). Specifically, our models comprise ResNet-{50, 101, 152}, ConvNext-{T, S, B}, DeiT-{T, S, B}, and Swin-{T, S, B}. To explore both the generalizability of ImageNet models and the genuine representation learning capacity of various architectures, we examine different architectures in two settings: (1) fine-tuning the ImageNet pretrained models, and (2) training target models with different architectures from random initialization (i.e. scratch). We evaluate all models on 8 medical imaging tasks, including binary classification (tuberculosis disease), multi-class classification (five and fourteen thoracic diseases), lesion segmentation (breast cancer and pneumothorax), and organ segmentation (lung, heart, and clavicle).

Observations and Analysis: FIG. 2 presents the results of fine-tuning 12 different pretrained ImageNet models on eight downstream tasks, along with the number of parameters for each model and their top-1 accuracy on ImageNet. In particular, FIG. 2 highlights a comparison of transfer learning from supervised ImageNet models across conventional and modern ConvNet and vision transformer architectures. ConvNext, among all architectural designs under study, consistently showcases superior performance within the majority of target tasks, underscoring its potential for creating high-performance models for medical imaging applications. Specifically, the ConvNet-B pretrained model behaves consistently across al tasks, compared with the erratic patterns displayed by other pretrained models. In this parallel coordinate plot, four variables-architecture variants, the number of parameters in each pretrained model, ImageNet top-1 accuracy, and performance on various medical downstream tasks—have been covered. “Arch,” and “IN Acc” denote architecture and top-1 accuracy on ImageNet, respectively. Furthermore, to distinguish between model families, consistent color schemes (gray for ResNet-(50, 101, 152), green for DelT (T, S, B), blue for Swin-(T, S, B) and purple for ConvNext-(T, B, S) have been used. Within each family, to distinguish different parameter sizes, difference patterns have been used: models with fewer parameters have “dotted lines” and those with a moderate number of parameters have dashed lines, and those with more parameters have “solid lines.”

The following observations can be drawn from the results: (1) ConvNext demonstrates superiority over other architectural designs in almost all target tasks and its variants achieves performance comparable to top-performing architectures (Swin-B and ResNet-152) in DXC₅ and DXC₁₄ tasks. This underscores ConvNext's superior capability in creating high-performance models for medical imaging applications. (2) In both vision transformers and ConvNets, the pretrained models with modern families demonstrate general dominance over their conventional counterparts. Particularly, pretrained models with Swin backbones (tiny, small, and base) consistently exhibit superior performance compared with their counterparts with DeiT backbones, including DeiT-T, DeiT-S, and DeiT-B, across all target tasks. This underscores Swin's capability in capturing hierarchical representations, enabling the flexibility to model visual concepts at different scales. Similarly, the pretrained models with ConvNext backbones (tiny, small, and base) outperform their counterparts with ResNet backbones, including ResNet-50, ResNet-101, and ResNet-152, in all target tasks except DXC₁₄. For example, the pretrained model pretrained with ConvNext-S achieves better performance than the one with ResNet-152 backbone in almost all target tasks, despite having a less complex model (50M vs. 60M). This highlights the efficacy of design choices in ConvNext, which modernize the standard ResNet towards the design of the Swin transformer. (3) Pretrained models with comparable model sizes (#param.) exhibit diverse behaviors across various applications, which may not necessarily correlate with their performance on ImageNet. For example, the pretrained model on Swin-B and ConvNext-B, both having almost the same number of parameters (88M vs. 89M), demonstrate competitive performance on ImageNet (i.e., 83.5% vs. 83.8%). But, when transferred to medical tasks, a performance disparity emerges between them, despite having the same number of parameters and leveraging identical pretraining and fine-tuning data. For example, in TXC, BUS, and CXS, the ConvNext-B outperforms Swin-B by substantial margins of 1.15%, 2.38%, and 3.76%, respectively. Similar trends can be observed when comparing Swin-S and ConvNext-S models. (4) As the task becomes more challenging due to the factors such as the nature of the task (e.g., disease segmentation) or the size of the object of interest, the disparity in performance between competitive pre-trained models becomes more pronounced. Notably, in organ segmentation tasks, as the size of organs decreases, the performance gap between the competitive models increases. For example, the performance gap between ConvNext-B and Swin-B widens to 0.37%, 0.76%, and 3.76% in lung (LXS), heart (HXS), and clavicle (CXS) segmentation tasks, respectively. A similar trend emerges when comparing Swin-S and ConvNext-S models, where the performance gap progressively increases as the organ size in LXS, HXS, and CXS decreases. These observations underscore the importance of varying backbone choices for model pretraining, where even choices with minimal impact on ImageNet performance can markedly influence transfer learning results in medical tasks.

To provide deeper insights into the genuine representation learning capacity of various architectures, we train a representative set of architectures from scratch on eight target datasets. Particularly, we consider two groups of architectures that have a compatible number of parameters: (1) Swin-T and ConvNext-T, and (2) Swin-B and ConvNext-B. As seen in FIG. 3, ConvNet variants excel in all tasks except BUS, achieving either the best or second-best performance. In particular, FIG. 3 includes a comparison of training target models with different architectures from random initialization. ConvNet variants (i.e., ConvNext-T and ConvNext-B) excel in all tasks except BUS, achieving either the best or second-best performance compared with Swin variants. This demonstrates the stronger inductive biases inherent to ConvNets, leading to a higher efficacy in medical imaging tasks with limited annotated data compared with vision transformers. The bar charts group architectures with a similar number of parameters: (1) Swin-T and ConvNext-T, and (2) Swin-B and ConvNeXt-B. Model names are listed on the Y-axis of the left-most figure in both rows. Different colors are used to distinguish each model with the same architecture family sharing thee same color (green for the ConvNext family and blue for the Swin family) but with different hues for their variants (lighter for models in the first group with fewer parameters and sharper models in the second group with more parameters). The X-axis represents the performance metric used for evaluation in each task: AUC classification tasks and Dice for segmentation tasks.

Moreover, consistent with results in the transfer learning setting shown in FIG. 2, ConvNext models outperform their Swin counterparts across nearly all tasks. This could be attributed to the stronger inductive biases inherent to ConvNets compared with vision transformers, leading to higher efficacy in medical imaging tasks with limited annotated data. In summary, our observations suggest that ConvNext variants compete favorably against their Swin counterparts in both transfer learning and, notably, in training from scratch settings. This could serve as a reminder that ConvNets are far from obsolete, highlighting their continued relevance and effectiveness in medical image analysis.

### 3.2. ConvNets are More Annotation Efficient than Vision Transformers in Fine-Tuning for Medical Imaging Tasks

In medical image analysis, where the quest for accurate and robust models reigns supreme, one formidable challenge is the scarcity of annotated data. Therefore, the concept of annotation efficiency becomes pivotal and plays a critical role in this context (Tajbakhsh et al., 2021). Due to the superior performance of vision transformers in various vision-related benchmarks, they have recently gained prominence in the field of computer vision, leading to the suggestion that they could serve as alternatives to ConvNets in a range of tasks (Khan et al., 2022; Liu et al., 2023b). However, vision transformers lack typical inductive biases inherent to ConvNets, such as translation equivariance and locality, making them more reliant on substantially larger amounts of data (Steiner et al., 2022; Tay et al., 2022; Touvron et al., 2021).

Vision transformers have recently shown potential for medical tasks (Li et al., 2023; Shamshad et al., 2023). Their superiority over ConvNets has been demonstrated in some medical applications by fine-tuning vision transformer pretrained models with large-scale domain-specific datasets (Matsoukas et al., 2021; Usman et al., 2022; Xiao et al., 2023). However, existing works have neglected fine-tuning vision transformer pretrained models using smaller amounts of labeled data, leaving a gap in understanding their performance on medical tasks with a dearth of annotated data. Considering the dependency of vision transformers on large amounts of fine-tuning data, we hypothesize that pretrained ConvNet models can provide a more annotation-efficient solution for medical tasks. To test this hypothesis, we conduct a systematic comparison between pretrained models with recent popular vision transformer and ConvNet backbones across a spectrum of medical applications. Our analysis encompasses varying amounts of fine-tuning data, ranging from limited to extensive, with a specific emphasis on providing nuanced insights into annotation efficiency of ConvNets and vision transformers for medical imaging.

Experimental setup: We evaluate the transferability of a representative set of pretrained models with modern vision transformer and ConvNet backbones across various medical applications. Our goal is to investigate the impact of fine-tuning data size on the performance of vision transformers compared with ConvNets in medical imaging. Given this goal, we employ pretrained models with variants of ConvNext, DeiT, and Swin transformer backbones, and fine-tune them for different applications, which are characterized by varying amounts of labeled data, ranging from modest datasets (i.e. 100 samples) to considerably larger ones (i.e. 368K samples). To conduct fair comparisons between ConvNet and transformer models, we control other influencing factors, particularly the number of model parameters and pretraining strategy. Specifically, we compare variants of different architectures that have a compatible number of parameters, creating two groups of comparable models: (1) ConvNext-T, Swin-T, and DeiT-S, which have ˜28M parameters, and (2) ConvNext-B, Swin-B, and DeiT-B, which have ˜88M parameters. Furthermore, we use existing official and readily available pretrained models on the ImageNet-1K dataset for all the network backbones under the study.

Observations and Analysis: FIG. 4 shows how increasing the amount of fine-tuning data leads to the narrowing of the performance gap between ConvNet (i.e. ConvNext) and vision transformer (i.e., Swin and DeiT) models. FIG. 4 shows that fine-tuning data size plays a vital role in bridging the performance gap between ConvNets and vision transformers in medical imaging tasks. As seen, increasing the amount of fine-tuning data from the left most subfigure (clavicle segmentation with a small amount of fine-tuning data) to the right most subfigure (14 thoracic diseases classification with a substantially higher amount of fine-tuning data) leads to a decrease in the performance gap between ConvNet (i.e. ConvNext) and transformer (i.e. Swin and DeiT) models. Particularly, in the top row of the figure, increasing the amount of fine-tuning data narrows the performance gap between ConvNext-T and Swin-T for all tasks. Similarly, in the bottom row of the figure, the performance gap between ConvNeXt-B and the best performing transformer, either Swin-B or DeiT-B, decreases as the amount of fine-tuning data increases. These findings highlight the annotation efficiency advantage offered by pretrained ConvNet models in medical imaging tasks.

As seen, moving from left to right (i.e., from clavicle segmentation to thoracic diseases classification), the transfer performance gap between ConvNext and Swin/DeiT pretrained models decreases as the amount of fine-tuning data increases. Particularly, in the clavicle segmentation task, the performance gap between ConvNext-T and best performing transformer model (i.e. Swin-T) is 3.7%, but this gap progressively decreases as the amount of fine-tuning data increases in the other tasks. Notably, the gap narrows to 2.2% in tuberculosis classification, 1% in pneumothorax segmentation, and 0.5% in thoracic disease classification tasks. Similar trends are observed when comparing ConvNext-B with Swin-B and DeiT-B. As shown in the bottom row of FIG. 4, the performance gap between ConvNext-B and the best performing transformer (i.e. Swin-B) in the clavicle segmentation task is 3.8%, while this gap reduces to 1.2%, 1.2%, and 0.04% in tuberculosis classification, pneumothorax segmentation, and thorax disease classification tasks, respectively. These results suggest that ConvNets are more annotation efficient than transformers when fine-tuned for medical tasks.

To further support this finding, we conduct supplementary experiments under controlled conditions. Specifically, we examine the ConvNext-B and Swin-B pretrained models for classification tasks by systematically varying the fine-tuning dataset size, ranging from a smaller-scale dataset of 9K training samples to a larger-scale dataset of 368K training samples. To provide a more comprehensive evaluation, we also include results of training the target models from random initialization (i.e. scratch) in each portion of the labeled data. FIG. 5 depicts the performance gap between Swin-B and ConvNext-B models across different amounts of labeled data in both training from scratch and fine-tuning scenarios. As indicated, the size of the training dataset impacts ConvNet and vision transformer models in both training from scratch and transfer learning settings. As seen, when trained from scratch, ConvNext-B model displays consistent superiority over Swin-B, with the performance gap narrowing as the dataset size increases. Conversely, in the transfer learning setup, Swin-B initially lags behind ConvNext-B but gradually overtakes it as the finetuning dataset size grows. These results highlight the superior annotation efficiency of ConvNets compared with vision transformers, and also underscore the vision transformers' potential for medical imaging tasks when abundant data is available.

As seen, there is a substantial performance gap between Swin-B and ConvNext-B models when trained from scratch. Indeed, regardless of the amount of the training data, ConvNext-B model consistently surpasses its Swin-B counterpart. Nevertheless, as the amount of labeled data increases from 9K to 368K, this performance gap gradually decreases from 10.3% to 1.8%. This observation underscores the data-intensive nature of vision transformers compared with ConvNets. On the other hand, in the transfer learning setup, different patterns emerge in comparison to training from scratch. Moving from the left to the right of the FIG. 5, it is apparent that using lower amounts of fine-tuning data, Swin-B lags behind ConvNext-B. Nevertheless, the performance gap gradually decreases from 2.8% to 0.04% as the amount of fine-tuning data increases from 9K to 86K. Furthermore, as the fine-tuning dataset size is further scaled up from 86K to 368K, the Swin-B model exhibits superior performance compared with the ConvNext-B model. In summary, our observations suggest that ConvNets exhibit greater annotation efficiency than transformers when fine-tuned for medical imaging tasks, while also highlighting the potential of vision transformers to compete favorably with ConvNets, especially when substantial data is available.

### 3.3. Fine-Grained Pretrained Models Offer a Superior Alternative to De-Facto ImageNet-1K Pretrained Models for Fine-Grained Medical Imaging Tasks

In medical imaging research, there has been a predominant trend of utilizing pretraining models on coarse-grained photo-graphic image datasets, with ImageNet-1K being the dataset of choice (Tajbakhsh et al., 2016; Raghu et al., 2019; Azizi et al., 2021; Wen et al., 2021; Matsoukas et al., 2022). This trend, driven by the sustained success of supervised ImageNet-1K models in various computer vision tasks over the last few years, has largely neglected the potential benefits of leveraging pretraining models on fine-grained photographic image datasets for medical tasks. Our study aims to address this gap in the literature by investigating the transferability of models pretrained on fine-grained datasets to myriad medical imaging tasks.

Fine-grained datasets are characterized by subtle visual differences between closely related classes, which are often embedded within local discriminative parts. Consequently, a model must capture these fine-grained details in order to effectively perform a recognition task (Chang et al., 2020; Zhao et al., 2020; Zhuang et al., 2020; Tang et al., 2023). This is particularly important in medical imaging, where accurate recognition of fine-grained medical conditions can have significant clinical implications (Haghighi et al., 2022; Hosseinzadeh Taher et al., 2022). We hypothesize that pretraining models on fine-grained datasets can lead to the derivation of distinctive local representations that are particularly useful for medical tasks, which often rely on small, local variations in texture to detect and segment pathologies/organs of interest. To test this hypothesis, we assess the transferability of models pretrained on large-scale fine-grained datasets to a range of target medical applications, shedding light on the impact of granularity of pre-training data in enhancing the effectiveness of medical recognition tasks. To the best of our knowledge, this study represents the first effort to rigorously evaluate the impact of pretraining data granularity on transfer learning to medical imaging tasks.

Experimental setup: We aim to compare the generalizability of the learned features from fine-grained pretraining datasets with the conventional pretraining on the ImageNet-1K dataset. To do so, we examine the effectiveness of four fine-grained datasets—iNat2021, ImageNet-22K, COCO, and Places365—as pretraining sources for medical imaging tasks. Each of these datasets possesses distinctive attributes that can contribute to the development of fine-grained pretrained models. For instance, iNat2021 and ImageNet-22K offer fine-grained class labels, empowering the model to learn subtle differences be-tween similar categories. COCO, on the other hand, provides fine-grained label structures, particularly through pixel-level instance segmentation, enhancing the model's capability in capturing detailed features required for precise object delineation. Furthermore, in Places365, where images of different scene categories may share similar appearances and objects, a heightened attention to fine-grained details is necessary for the model to effectively solve the scene recognition task. More details about these datasets can be found in Appendix A. We fine-tune existing official and publicly available pretrained models on these four datasets for 10 different target tasks, including multi-label classification, binary classification, and pixel-wise segmentation (see Table 1). For fair comparisons, all pretrained models use a ResNet-50 backbone.

Observations and Analysis: As evidenced in FIG. 6, fine-tuning from pretrained models on datasets with finer data granularity and greater data diversity consistently outperform the de-facto ImageNet-1K model across all six semantic segmentation tasks, including lesion segmentation in chest radiography (PXS) and ultrasound (BUS) images as well as organ segmentation in chest radiography (LXS, HXS, and CXS) and fundoscopic (VFS) images. Moreover, the ImageNet-1K model is significantly outperformed by the Places365 and ImageNet-22K pretrained models in pulmonary embolism classification in chest CT (ECC) and thoracic diseases classification in chest radiography (DXC₅), respectively. In the rest of classification tasks (TXC and DXC₁₄), ImageNet-1K models perform on par with the top-performing fine-grained pretrained models in each task. As shown, fine-tuning the models pretrained on large-scale finer grained datasets, namely iNat2021, ImageNet-22K, COCO, and Places365, offers a promising alternative to the de-facto ImageNet-1K pretrained model for fine-grained medical applications. As seen, all fine-grained models consistently outperform the ImageNet-1K model across all six semantic segmentation tasks. Moreover, the top-performing fine-grained models excel in ECC and DXC₅ classification tasks, while performing on par with the ImageNet-1K model in TXC and DXC₁₄ classification tasks. These results highlight that pretrained models on fine-grained data capture subtle features that empower fine-grained medical imaging tasks.

In FIG. 6, it is noteworthy that a significant performance gap is observed in challenging semantic segmentation tasks, such as breast cancer (BUS), pneumothorax (PXS), heart (HXS), and clavicle (CXS) segmentation, where the ImageNet-1K model is outperformed by the best fine-grained pretrained models by margins of 5.52%, 1.66%, 1.25%, and 1.53%, respectively. This suggests that pretrained models on datasets with finer data granularity and diverse data yield a more fine-grained visual feature space that captures essential pixel-level cues for medical segmentation tasks. In summary, our observations suggest that fine-grained pretrained models offer a viable alternative for transfer learning in fine-grained medical tasks. We hope that practitioners will find this observation valuable in transitioning from standard ImageNet-1K models and leveraging the benefits we have demonstrated in building high-performance medical imaging models.

### 3.4. Self-Supervised ImageNet Models Offer More Holistic Features than Supervised ImageNet Models for Medical Imaging Tasks

A recent family of self-supervised ImageNet models has been shown to outperform supervised ImageNet models in a growing number of computer vision tasks (Ericsson et al., 2021; Islam et al., 2021; Zhao et al., 2021). In contrast to the supervised pretraining scheme, where models are optimized for specific tasks (e.g. ImageNet classification) via using labeled data, self-supervised pretraining involves directly extracting knowledge from unlabeled data, resulting in the capture of task-agnostic features that can be easily adapted to different target tasks (Islam et al., 2021; Wei et al., 2022). Particularly, self-supervised learners attune to larger image regions (Erics-son et al., 2021; Zhao et al., 2021), empowering them to derive richer visual information from the entire image. Supervised pretraining, on the other hand, encourages the model to primarily focus on the smaller discriminative regions of the images and retain more domain-specific high-level information, resulting in lower generalizability of their learned features, particularly when the distributions of the source and target data differ significantly. We hypothesize this phenomenon is more pronounced in the medical domain, where there is a remarkable domain shift (Ericsson et al., 2021) compared with ImageNet, originating from the marked differences between photographic and medical images. To test this hypothesis, we analyze the effectiveness of a wide range of recent self-supervised methods, including contrastive learning, clustering, knowledge distillation, and information maximization methods, across various modalities spanning X-ray, Ultrasound, CT, and fundoscopy images. To the best of our knowledge, this study marks the first rigorous attempt to benchmark such a diverse set of SSL techniques across a broad range of medical imaging tasks.

Experimental setup: We assess the transferability of 22 SOTA self-supervised learning (SSL) methods with officially released models, which have been expertly optimized, on 10 diverse medical imaging tasks. These SSL methods can be broadly categorized into two main groups: image-level, and dense-level approaches. Image-level approaches focus on learning global image features, which can be broadly classified into (1) Contrastive learning: InsDis (Wu et al., 2018), PIRL (Misra and Maaten, 2020), MoCo-v1 (He et al., 2020), MoCo-v2 (Chen et al., 2020c), SimCLR-v1 (Chen et al., 2020a), SimCLR-v2 (Chen et al., 2020b), InfoMin (Tian et al., 2020), and CLSA (Wang and Qi, 2023), (2) Clustering: DeepCluster-v2 (Caron et al., 2020b) and SeLa-v2 (Caron et al., 2020b), (3) Clustering-based contrastive learning: PCL-v1 (Li et al., 2021), PCL-v2 (Li et al., 2021), and SwAV (Caron et al., 2020b), (4) Knowledge distillation: BYOL (Grill et al., 2020), DINO (Caron et al., 2021), SimSiam (Chen and He, 2021), and OBVW (Gidaris et al., 2021), and (5) Information maximization: Barlow Twins (Zbontar et al., 2021). Dense-level approaches focus on learning local image features, which can be broadly classified into (1) Contrastive learning at pixel level: PixPro (Xie et al., 2021b), (2) Contrastive learning at feature-map level: DenseCL (Wang et al., 2021b), (3) Contrastive learning at patch level: DetCo (Xie et al., 2021a), and (4) Information maximization at patch level: VICRegL (Bardes et al., 2022b). All the SSL methods under the study are pretrained on ImageNet-1K dataset using the ResNet-50 architecture, and their detailed descriptions can be found in Appendix C. We consider a standard supervised pretrained model on ImageNet-1K with a ResNet-50 backbone as the baseline.

Observations and Analysis: As shown in FIG. 7, in each target task, at least three self-supervised ImageNet models outperform the supervised ImageNet model on average. Notably, recent SSL approaches such as DINO, SwAV, Barlow Twins, SeLa-v2, and DeepCluster-v2 consistently outperform the supervised ImageNet model in (almost) all target tasks. In particular, FIG. 7 shows self-supervised learners can capture holistic features more effectively than their supervised counterparts, resulting in more generalizable representations for a variety of medical imaging tasks. As seen, a majority of self-supervised ImageNet models outperform supervised models in terms of mean performance across at least three target tasks. This underscores the greater transferability of self-supervised representation learning. Notably, recent approaches such as DINO, SwAV, Barlow Twings, SeLa-v2, and DeepCluster-v-2 consistently outperform the supervised ImageNet model in (almost) all target tasks. For each of reference, each of the 22 self-supervised methods is now categorized into nine main groups, with each group represented by a distinct color in the plots. The methods are listed in numerical order from left to right.

This observation from FIG. 7 could be attributed to the fact that supervised pretraining labels encourage the model to retain more task-specific high-level representations, leading to a biased learned representation towards the pretraining task/dataset's idiosyncrasies. Conversely, self-supervised learners capture low/mid level features that are not attuned to domain-relevant semantics, leading to better generalization to diverse target tasks, especially those with limited data. More importantly, comparing the performance of self-supervised learners versus supervised baseline in segmentation tasks (HXS, CXS, PXS, LXS, BUS, and VFS) and classification tasks (DXC₅, DXC₁₄, TXC, and ECC) in FIG. 7, it is evident that a larger number of SSL methods yield superior transfer performance in the former compared with the supervised pretraining. Our results indicate that SSL models are more effective in handling larger domain shifts and achieving precise localization than supervised models. This could be attributed to the capability of SSL models in capturing discriminative representations from the entire image, in contrast to supervised pretrained models that primarily focus on smaller discriminative regions. In summary, our observations suggest that SSL approaches excel in capturing holistic features effectively, leading to higher transferability across diverse medical imaging tasks. Hence, SSL pretrained models can provide a much better initialization point for deep networks in medical imaging, enhancing target task performance. This can also show their potential in addressing challenges like vanishing and exploding gradients, which are common in medical applications due to annotation scarcity. We hope our findings, echoing with recent studies in computer vision (Islam et al., 2021; Ericsson et al., 2021; Zhao et al., 2021; Kim et al., 2022), will lead to a more promising pathway for more effective transfer learning in medical imaging.

### 3.5. Domain-Adaptive Pretraining Develops Performant Models by Harnessing ImageNet Knowledge and Readily Accessible Expert Annotations Associated with Medical Datasets

Pretrained models on large-scale datasets, particularly ImageNet, have emerged as a popular approach for transfer learning in myriad vision tasks due to several factors, including but not limited to: (a) they are free and easily accessible; (b) they are more efficient than training models from scratch in terms of both performance and resource usage (Yosinski et al., 2014; Frankle and Carbin, 2019); and (c) they are capable of extracting generic features that can be reused for other tasks or domain-specific datasets (Kornblith et al., 2019; Matsoukas et al., 2022). Despite the prevalence of ImageNet pretrained models, they may not be the optimal choice for transfer learning in medical imaging. This is due to the significant covariate shift between photographic and medical images that limits the models' ability to adapt to medical datasets, thus hindering their efficacy in transfer learning to medical imaging (Raghu et al., 2019; Azizi et al., 2021; Haghighi et al., 2022).

Domain-adaptive pretraining techniques have shown potential in tackling the challenge of domain shift between photographic and medical images (Liu et al., 2019; Li et al., 2020; Chen et al., 2021; Haghighi et al., 2023). The domain-adaptive pretraining paradigm originated in natural language processing (Pan and Yang, 2010; Glorot et al., 2011; Gururangan et al., 2020) and has subsequently expanded to the vision field. The domain-adaptive paradigm is a sequential pretraining approach in which a model is first pretrained on a massive general dataset, such as ImageNet, and then pretrained on domain-specific datasets, resulting in domain-adapted pretrained models (Yosinski et al., 2014; Shin et al., 2016). While some studies (Azizi et al., 2021, 2023) have shown the potential of continued pretraining on domain-specific medical data, these studies have been limited to classification tasks and conventional ResNet models. To bridge this gap, we comprehensively explore the efficacy of domain-adaptive pretraining on photographic and medical datasets to tune ImageNet models for medical imaging tasks. In contrast to previous works, we develop domain-adapted models with SOTA ConvNet and vision transformer architectures and evaluate them on a wide range of tasks.

Experimental setup: To demonstrate the efficacy of domain-adaptive pretraining, we consider supervised ImageNet pre-trained models with ConvNet and vision transformer back-bones, including ResNet-50, ConvNext-B, and Swin-B, and then adopt them to medical applications. To do so, we follow a two-step pretraining process, where the models with each backbone are first pretrained on ImageNet dataset, followed by supervised pretraining on three medical imaging datasets, including ChestX-ray14 (ImageNet→ChestX-ray14), CheXpert (ImageNet→CheXpert), and MIMIC-CXR (ImageNet→MIMIC). We evaluate the domain-adapted models by fine-tuning them for a myriad of medical applications, encompassing various challenging tasks (classification and segmentation) and organs (e.g. heart, clavicle), and diseases (e.g. thoracic diseases, tuberculosis, and pneumothorax). We compare each domain-adapted model with a supervised ImageNet model with the same backbone architecture.

Observations and Analysis: FIG. 8 shows the fine-tuning performances of three domain-adapted models with ResNet-50 backbone pretrained on ChestX-ray14, CheXpert, and MIMIC-CXR datasets on six target tasks. Domain-adaptive pretraining serves as a vital bridge between the photographic and medical imaging domains, leading to improved performances compared with the standard ImageNet pretraining in all target tasks. Particularly, ImageNet→ChestX-ray14 and ImageNet→CheXpert domain-adapted models exhibit significantly better performance (p<0.05) compared with the standard ImageNet pretrained model in DXC₁₄, DXC₅, TXC, and PXS, and comparable performance in CXS and HXS target tasks. Furthermore, increasing the amount of in-domain data through the utilization of the MIMICCXR dataset results in significant gaps (p<0.05) between domain-adapted (ImageNet→MIMIC) and ImageNet models in all target tasks, highlighting the crucial role of the data scale in effectively bridging the gap between photographic and medical images.

As seen, all three domain-adapted models consistently outperform the standard ImageNet pretrained model across all target tasks. Specifically, based on the statistical analysis, all domain-adapted models exhibit significant performance boosts (p<0.05) compared with the ImageNet model in PXS, TXC, DXC₁₄, and DXC₅ target tasks, with an average performance improvement of 2%, 1.8%, 0.5%, and 0.6%, respectively. Furthermore, in CXS and HXS target tasks, the ImageNet→ChestX-ray14 and ImageNet→CheXpert domain-adapted models exhibit improved average performance compared with the ImageNet model, with their p-values indicating comparability. However, as the amount of in-domain data increases through the utilization of the MIMIC-CXR dataset, we observe that the performance gap between the ImageNet and domain-adapted model (ImageNet→MIMIC) increases by 1.4% and 0.9%, respectively, leading to statistically significant boosts (p<0.05) when compared with the ImageNet baseline. This underscores the pivotal role of the scale of domain-adapting data in effectively bridging the gap between photographic and medical images.

To further demonstrate the advantage of domain-adaptive pretraining, we evaluate the transferability of domain-adapted models with more sophisticated ConvNet and vision transformer backbones, namely ConvNext-B and Swin-B, pre-trained on largest in-domain dataset (i.e. MIMIC-CXR). FIG. 9 depicts the comparison between ImageNet→MIMIC domain-adapted models with ConvNext-B and Swin-B backbones and their corresponding ImageNet pretrained models counterparts on six target tasks. Domain-adaptive pretraining can boost the performance of ImageNet models with modern ConvNet (i.e. ConvNext-B) and vision transformer (i.e. Swin-B) backbones. Particularly, our ImageNet→MIMIC domain-adapted models with ConvNext-B and Swin-B backbones consistently demonstrate superior performance (p<0.05) compared with their corresponding ImageNet counterparts. Moreover, comparing ImageNet→MIMIC domain-adapted models with ConvNext-B and Swin-B backbones, the former exhibits superior performance in target tasks with relatively smaller datasets (TXC, PXS, CXS, and HXS), while the latter demonstrate equivalent or superior performance in target tasks with larger datasets (DXC₁₄ and DXC₅), reiterating the superior annotation efficiency of pretrained models with ConvNets compared with those with vision transformer backbones (see Sec. 3.2).

As seen, both domain-adapted models consistently surpass the standard ImageNet-pretrained model with the same backbone across all target tasks, yielding significant performance boosts (p<0.05) in PXS, TXC, DXC₁₄, CXS, and HXS target tasks. Furthermore, comparing the performance of ImageNet→MIMIC domain-adapted models with ConvNext-B and Swin-B backbones, both of which have a comparable number of model parameters (89M vs. 88M), the domain-adapted model with ConvNext-B backbone outperforms its Swin-B counterpart in target tasks with relatively smaller datasets (e.g. TXC, PXS, CXS, and HXS). Conversely, in target tasks with larger datasets (e.g., DXC₁₄ and DXC₅), the domain-adapted model with the Swin-B backbone provides significantly better or equivalent performance compared with the ConvNext-B model. This observation, in line with our results in Sec. 3.2, highlights the superior annotation efficiency of pretrained models with ConvNext compared with Swin backbones.

In summary, our domain-adaptive pretraining approach harnesses knowledge acquired from a large-scale photographic dataset (ImageNet) and enhances it by incorporating readily conducted annotation efforts derived from three distinct medical datasets of varying sizes, ranging from 86K to 368K—leading to the development of more performant medical imaging models. Notably, the utilization of the MIMIC-CXR dataset, the largest in-domain dataset in our study, results in the best-performing domain-adapted model (ImageNet→MIMIC), which outperforms the other two domain-adapted models using ChestX-ray14 and CheXpert datasets. In light of this observation, we foresee that harnessing even larger in-domain datasets can unleash the full potential of our domain-adaptive pretraining approach. Nevertheless, the substantial cost associated with annotating medical images has led to a scarcity of large-scale medical imaging datasets. While numerous publicly available medical imaging datasets do exist, they often suffer from limited sizes. Furthermore, the proliferation of these datasets contributes to heterogeneity and discrepancies in expert labeling. We believe that future research focused on label aggregation methods (Liu et al., 2023a; Kang et al., 2023), capable of effectively assembling labels from different datasets, holds significant promise for creating larger-scale datasets that can pave the way for training more robust domain-adapted models for medical imaging applications. All our domain-adapted pretrained models (ImageNet→ChestX-ray14, ImageNet→CheXpert, and ImageNet→MIMIC) with both ConvNet and vision transformer backbones are publicly available on our GitHub page.

### 4. Discussion

### 4.1. RadImageNet Vs. ImageNet

It is undeniable that a significant domain gap exists between photographic images and medical images. But, the question that naturally arises is: why has transfer learning from photographic images, particularly those in the ImageNet, to medical images become the de-facto standard for medical image analysis? The answer primarily lies in the lack of a massive labeled dataset for medical image analysis, akin to ImageNet for computer vision. Most publicly accessible medical imaging datasets, such as U.K. Biobank (Bycroft et al., 2018), MIMIC-CXR (Johnson et al., 2019), and CheXpert (Irvin et al., 2019) are limited in scale and lack diverse images paired with high-quality pathological labels, thereby hindering successful transfer learning in medical image analysis.

Recently, the RadImageNet dataset (Mei et al., 2022) has been developed, comprising 1.3 million medical images annotated by fellowship-trained and board-certified radiologists. RadImageNet's primary goal is to develop pretrained models exclusively from medical imaging data, rather than photographic images, to serve as the basis for transfer learning in medical applications. To assess the effectiveness of RadImageNet models compared with de-facto ImageNet models for transfer learning in medical tasks, we employ their official pretrained models with the same backbone (ResNet-50) and evaluate their generalizability across a wide range of tasks.

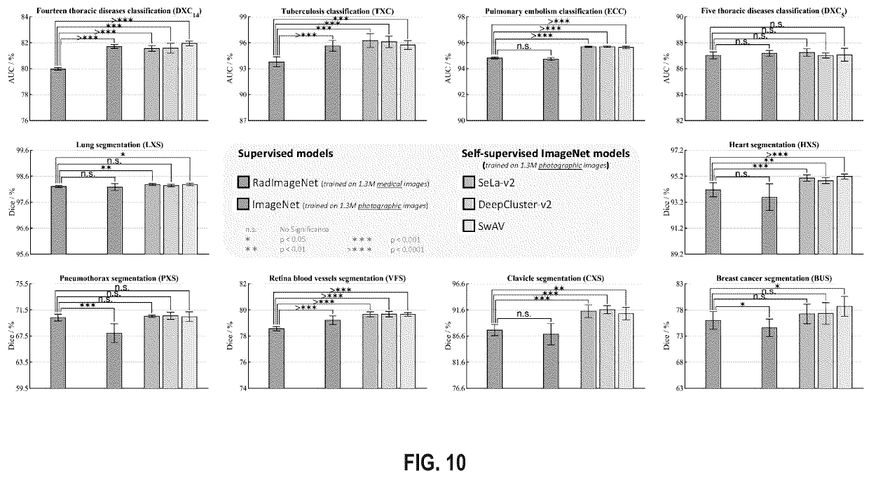

Results, depicted in FIG. 10, revealed that ImageNet models achieve superior or comparable performance when compared with RadImageNet models. FIG. 10 shows that fine-tuning ImageNet pretrained models remains a valuable resource for fostering high-performance models in medical imaging. Notably, ImageNet models consistently demonstrate superior or comparable performance when compared with supervised RadImageNet models. Specifically, the supervised ImageNet model excels in DXC₁₄, TXC, and VFS, performs at par in DXC₅, ECC, LXS, HXS, and CXS, and lags slightly behind RadImageNet in PXS and BUS. More importantly, the top-performing self-supervised ImageNet models, including SeLa-v2, DeepCluster-v2, and SwAV, consistently outperform supervised RadImageNet model across all tasks.

As indicated, the supervised ImageNet model outperforms supervised RadImageNet model significantly in DXC₁₄, TXC, and VFS, achieves equivalent performance in DXC₅, ECC, LXS, HXS, and CXS, and falls slightly behind RadImageNet in PXS and BUS. Importantly, the top self-supervised ImageNet models (SeLa-v2, DeepCluster-v2, and SwAV), according to our findings in Sec. 3.4, consistently outperform supervised RadImageNet models across all tasks. This observation, in line with our findings in FIG. 7, reinforces the importance of SSL for offering a new transfer learning standard for medical imaging. In summary, our results demonstrate that the ImageNet dataset remains a fundamental resource for deriving sophisticated pretrained models to develop high-performance medical imaging models with high generality. It is worth noting that, due to the unavailability of self-supervised models pretrained on RadImageNet in the public domain, we were unable to evaluate their generalizability compared with both supervised RadImageNet and supervised/self-supervised ImageNet models. We envisage that pretraining self-supervised models with RadImageNet could provide deeper insights into transfer learning for medical imaging, serving as a focus for our future research efforts.

### 4.2. In-Domain Self-Supervised Vs. Supervised Learning

The superior transferability of self-supervised ImageNet models over their supervised counterparts has been showcased in Sec. 3.4. To delve deeper into this phenomenon, we examine the potential of using medical images, instead of photographic images (ImageNet), as the pretraining source for a diverse set of self-supervised methods with different objectives, including SOTA image-level: MoCo-v2 (He et al., 2020), patch-level: TransVW (Haghighi et al., 2021), VICRegL (Bardes et al., 2022a), DenseCL (Wang et al., 2021b), and Adam (Hossein-zadeh Taher et al., 2023), and pixel-level: PCRL (Zhou et al., 2021a) and DiRA (Haghighi et al., 2022) methods. Among these, TransVW, PCRL, DIRA, and Adam represent SOTA methods designed specifically for medical tasks.

Due to the lack of publicly available pretrained models for these methods, we strive to provide a fair comparison for better insights into the generalizability of self-supervised vs. supervised learned representations by controlling other confounding factors such as pretraining data and backbone architecture. Specifically, all the SSL methods under study are pretrained on the training set of ChestX-ray14 dataset using ResNet-50 backbone. The supervised model is pretrained on ChestX-ray14, serving as the upper-bound in-domain transfer learning baseline with the same backbone (ResNet-50). All pretrained models are fine-tuned for seven distinct chest X-ray classification and segmentation applications, each exhibiting significant domain shifts in terms of data distribution and disease/object of interest. The results of training downstream models from random initialization are reported as the performance lower-bound.

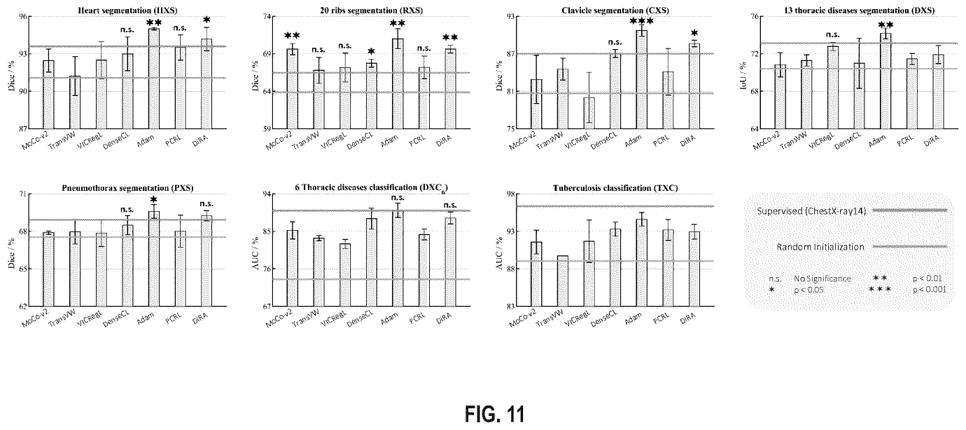

Referring to FIG. 11, self-supervised learning using medical images holds the potential to yield more generalizable representations than those acquired through in-domain supervised learning. As seen, in nearly all tasks, at least two self-supervised learners exhibit comparable or superior performance compared with the supervised in-domain model, highlighting the significant potential of SSL in providing more generalizable representations in medical imaging.

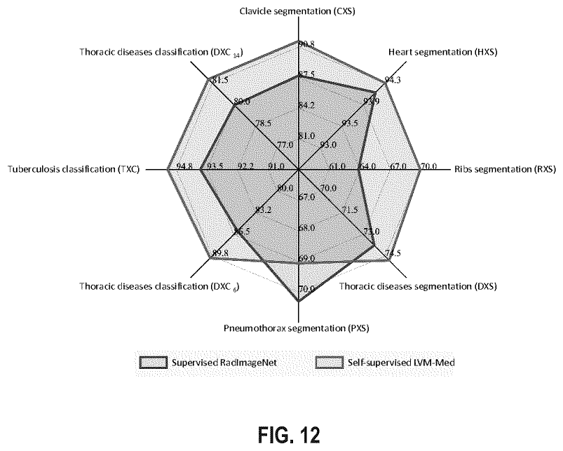

As seen in FIG. 11, in all tasks except TXC, there are at least two self-supervised learners that deliver comparable or superior performance compared with the supervised in-domain model, underscoring the potential of self-supervised learners in capturing more generalizable representations compared with the supervised counterpart. Notably, as self-supervised learners capture discriminative representations from the entire image, unlike supervised learning that primarily focuses on smaller discriminative regions (i.e. diseases), they can acquire more transferable (low/mid-level) features, when employing an appropriate learning strategy. To further demonstrate this, we extend our analysis by considering two recently developed large-scale medical models: (1) RadImageNet, pretrained in a fully-supervised manner on 1.35 million medical images; and (2) LVM-Med (Nguyen et al., 2023), pretrained in a self-supervised manner on 1.3 million medical images. As seen in FIG. 12, while both RadImageNet and LVM-Med models utilize the same amount of pretraining data (˜1.3M) and backbone (ResNet50), LVM-Med, even though it only leverages unlabeled data and doesn't incorporate any expert knowledge like RadImageNet models, outperforms it across all tasks except PXS. This emphasizes the significant potential of self-supervised learning in providing more generic representations, particularly when employing a well-designed learning strategy in conjunction with a substantial amount of pretraining data. The self-supervised LVM-Med pretrained model demonstrates superior transfer performance across various target tasks compared with the fully-supervised RadImageNet pretrained model. Particularly, despite both models utilizing an equivalent amount of pretraining data (˜1.3M) and sharing the same backbone, LVM-Med outperforms RadImageNet in all tasks except PXS. This underscores the effcacy of self-supervised learning in generating more generalizable and robust representations in medical imaging, especially when well-designed self-supervised learning strategies are coupled with large-scale pretraining data.

The significance of self-supervised learning becomes even more pronounced in the context of 3D representation learning, where the substantial cost of annotating 3D medical images impedes the availability of large-scale annotated datasets, akin to ImageNet, for the pretraining generic 3D models. As evidenced by previous studies (Taleb et al., 2020; Zhu et al., 2020; Chaitanya et al., 2020; Zhou et al., 2021b; Haghighi et al., 2021; Zhou et al., 2023; Jiang et al., 2023), self-supervised pre-trained models have shown promise for different 3D applications. Nevertheless, the scarcity of publicly accessible self-supervised models pretrained for 3D medical data, coupled with the variability in pretraining settings and data, impedes a thorough analysis of these methods, pointing towards an important area for future research.

TABLE 2
Comparison of in-domain versus out-domain self-supervised pretraining.
We benchmarked top-performing self-supervised ImageNet models (SwAV,
Barlow Twins, SeLa-v2, DeepCluster-v2) against in-domain self-supervised
models (Medical MAE, RAD-DINO, LVMMed, Adam-v2). Adam-v2, outperforms
both in-domain and out-domain self-supervised models across all target
tasks. However, the second-best performing models are among the self-
supervised ImageNet models. These results highlight the importance of
a well-designed training strategy over merely scaling data or architectures
for effective in-domain self-supervised learning.

| | Pretraining data | | Downstream Tasks | | |
|---|---|---|---|---|---|
| | In- | Out- | PXS | HXS | CXS |
| SSL Method | domain | domain | (Dice %) | (Dice %) | (Dice %) |
| SwAV | | ✓ | 70.44 ± 0.75 | 95.17 ± 0.20 | 90.87 ± 1.21 |
| Barlow Twins | | ✓ | 70.42 ± 0.15 | 94.69 ± 0.70 | 91.3 ± 1.24 |
| SeLa-v2 | | ✓ | 70.52 ± 0.17 | 95.06 ± 0.24 | 91.32 ± 1.22 |
| DeepCluster-v2 | | ✓ | 70.59 ± 0.55 | 94.85 ± 0.23 | 91.63 ± 0.77 |
| Medical MAE | ✓ | | 70.35 ± 0.66 | 94.68 ± 0.47 | 88.81 ± 0.56 |
| RAD-DINO | ✓ | | 69.60 ± 1.33 | 94.20 ± 0.59 | 87.14 ± 0.54 |
| LVM-Med | ✓ | | 69.06 ± 1.26 | 94.35 ± 0.74 | 91.41 ± 1.56 |
| Adam-v2 | ✓ | | 71.28 ± 0.12 | 95.22 ± 0.06 | 92.47 ± 0.22 |

### 4.3. In-Domain Vs. Out-Domain Self-Supervised Learning

To gain a clearer understanding of in-domain versus out-domain self-supervised pretraining, we have compared public self-supervised models pretrained on large-scale medical images with self-supervised ImageNet models. According to our benchmarking analysis in Sec. 3.4, we considered the top-performing self-supervised ImageNet models that outperform the supervised ImageNet model across target tasks, including SwAV, Barlow Twins, SeLa-v2, and DeepCluster-v2. For the in-domain self-supervised models, we considered publicly available and official models of four recent medical models: Medical MAE (Xiao et al., 2023), pretrained on 500K images; RAD-DINO (Pérez-García et al., 2024), pretrained on 838K images; Adam-v2 (Taher et al., 2024), pretrained on ≈1M images; and LVMMed (Nguyen et al., 2023), pretrained on 1.3 million medical images in a self-supervised manner. We fine-tuned all models on three downstream tasks (PXS, HXS, and CXS tasks).

As seen in Table 2, the best in-domain self-supervised model, Adam-v2, outperforms both in-domain and out-domain self-supervised models across all target tasks. However, the second-best performing models are among the self-supervised ImageNet models. Specifically, in the PXS and CXS tasks, DeepCluster-v2 is the runner-up model, while in the HXS task, SwAV is the runner-up model. These observations suggest that the true potential of in-domain self-supervised learning can be fully realized if it leverages a well-designed learning strategy in conjunction with a substantial amount of pretraining data. In summary, in in-domain pretraining of self-supervised models, we envision that the design of the self-supervised training strategy should take precedence over merely scaling up data or architectures, because an effective training strategy may leverage the data more effectively, resulting in more generic and transferable representations for a variety of target tasks.

TABLE 3
We evaluate the robustness of pretrained models with modern ConvNet and vision transformer backbones under stress
testing by applying meaningful perturbations to the test images and measuring the models' performances on these
out-of-distribution samples in two downstream tasks. ImageNet pretrained model with ConvNext-B backbone demonstrate
higher robustness to distorted data over its Swin-B counterpart. Additionally, domain-adapted models demonstrate
significantly higher robustness to out-distribution samples compared with their corresponding ImageNet models.

| | | NIH Shenzhen (AUC %) | | | | | ChestX-ray14 (AUC %) | | | | |
|---|---|---|---|---|---|---|---|---|---|---|---|
| | | Perturbations on test data | | | | | Perturbations on test data | | | | |
| | | | | Bright- | Gaussian | | | | Bright- | Gaussian | |
| Pretraining | Backbone | Gamma | Contrast | ness | blur | None | Gamma | Contrast | ness | blur | None |
| ImageNet | Swin-B | 91.12 ± | 88.03 ± | 84.23 ± | 92.71 ± | 95.08 ± | 80.35 ± | 80.39 ± | 79.51 ± | 78.38 ± | 81.50 ± |
| | | 3.30 | 3.74 | 7.34 | 3.61 | 2.22 | 0.17 | 0.13 | 1.16 | 0.34 | 0.29 |
| ImageNet | ConvNeXt-B | 95.78 ± | 92.21 ± | 95.75 ± | 95.82 ± | 96.23 ± | 80.96 ± | 80.65 ± | 80.23 ± | 79.97 ± | 81.54 ± |
| | | 1.38 | 1.62 | 1.04 | 1.54 | 1.67 | 0.21 | 0.27 | 0.23 | 0.33 | 0.16 |
| ImageNet- | Swin-B | 94.87 ± | 88.37 ± | 84.98 ± | 94.58 ± | 97.12 ± | 81.97 ± | 81.84 ± | 81.37 ± | 78.66 ± | 82.57 ± |
| MIMIC | | 1.61 | 3.44 | 10.63 | 1.55 | 0.96 | 0.13 | 0.12 | 0.12 | 0.49 | 0.12 |
| ImageNet- | ConvNeXt-B | 97.85 ± | 97.55 ± | 98.01 ± | 97.83 ± | 98.35 ± | 81.52 ± | 81.34 ± | 81.02 ± | 80.59 ± | 82.21 ± |
| MIMIC | | 0.65 | 0.70 | 0.52 | 0.51 | 0.71 | 0.23 | 0.19 | 0.25 | 0.38 | 0.17 |

### 4.4. Robustness of Pretrained ConvNets and Vision Transformers Under Stress Testing

Despite the extensive growth of deep learning models in medical image analysis, there remain concerns regarding the generalizability and robustness of such models when processing new data with different distributions from the training data. These distribution shifts can occur due to changes in image acquisition, different scanner devices, or variations in patient populations. Therefore, stress testing, particularly on out-of-distribution test data, is crucial as it evaluates the models' ability to generalize and maintain performance when faced with data deviating from the training set distribution, thereby ensuring robustness and reliability in real-world applications. To give a more in-depth comparison between pretrained ConvNet and vision transformer models, we evaluate their robustness under stress testing. To do so, we apply meaningful perturbations to the input images and measure the performances of the models under the study on these out-of-distribution test samples. Specifically, we fine-tune ImageNet pretrained models with ConvNext-B and Swin-B backbones, as well as their corresponding domain-adapted pretrained models (i.e., ImageNet→MIMIC with ConvNext-B and Swin-B), for two downstream tasks: ChestX-ray14 (DXC₁₄) and NIH Shenzhen (TXC). Subsequently, during the inference phase, we randomly apply four different perturbations to the input images—gamma correction, contrast adjustment, brightness adjustment, and Gaussian blur—to modify the distribution of the test set. These perturbations ensure that the models' performances are measured under simulated yet realistic conditions that can occur in medical imaging (Islam et al., 2023). To analyze the robustness of the different pretrained models under study, we compare their performances with and without input perturbations.

TABLE 4
Comparison of the transferability of hybrid models (CvT and
DeiT), hierarchical transformer (Swin), and modern ConvNet
(ConvNeXt) pretrained models on three medical imaging tasks: TXC,
DXC₁₄, and DXC₅. As seen, the hybrid CvT model outperforms DeiT
across all tasks, consistent with their ImageNet top-1K accuracy. CvT and
DeiT perform competitively with Swin in the TXC task but fall behind
Swin in the DXC₅ and DXC₁₄ tasks, highlighting the advantages of
hierarchical transformers over conventional vision transformers in handling
large datasets. CvT lags behind ConvNeXt in the TXC task, but the
performance gap narrows as the amount of fine-tuning data increases
in DXC₁₄ and DXC₅. This emphasizes the greater annotation effciency
of modern ConvNet models like ConvNeXt and demonstrates the potential
of vision transformers to compete favorably with ConvNets when
substantial data is available.

| | Downstream Tasks | | |
|---|---|---|---|
| Backbone | TXC (AUC %) | DXC₁₄ (AUC %) | DXC₅ (AUC %) |
| DeiT | 95.08 ± 0.27 | 80.49 ± 0.05 | 86.55 ± 0.33 |
| CvT | 95.22 ± 0.85 | 80.98 ± 0.30 | 87.43 ± 0.24 |
| Swin | 95.08 ± 2.47 | 81.50 ± 0.29 | 87.80 ± 0.42 |
| ConvNeXt | 96.23 ± 1.67 | 81.54 ± 0.16 | 87.64 ± 0.53 |

We draw the following observations from the results in Table 3. (1) The overall trend showcases the higher robustness of the ImageNet pretrained model with ConvNext-B backbone over its Swin-B counterpart. Particularly, in line with our benchmarking results in normal test data (Sec. 3.1), ConvNext-B models show higher performance than their Swin-B counterparts across all tasks and perturbation functions, with an average boost of 2.6%, 2.2%, 6.1%, and 2.3% across target tasks when using gamma correction, contrast adjustment, brightness adjustment, and Gaussian blur perturbations, respectively. (2) ConvNext-B model shows lower degradation in performance when the test data is distorted compared with their Swin-B counterparts, which further reinforces the robustness of ConvNext-B models over their Swin-B counterparts. In particular, the ConvNext-B model shows average degradation across target tasks by 0.5%, 2.4%, 0.89%, 0.99% when using four perturbations respectively, while the Swin-B shows a significantly higher degradation in performance by 2.5%, 4.1%, 6.4%, and 2.7%. And, (3) Domain-adapted models demonstrate significantly higher robustness to out-distribution samples compared with their corresponding ImageNet models. In particular, ImageNet→MIMIC with ConvNext-B yields average performance boosts over its ImageNet counterpart by 1.3%, 3.0%, 1.5%, 1.3% when using four perturbations respectively. Similarly, ImageNet→MIMIC with Swin-B yields average performance boosts over its ImageNet counterpart by 2.7%, 0.9%, 1.3%, and 1.1% when using four perturbations respectively. In summary, these observations reinforce our results in Sec. 3.1 and Sec. 3.5, echoing the superiority of modern ConvNet backbones for medical tasks as well as the effectiveness of our domain-adaptive pretraining scheme for not only boosting the performance of ImageNet models but also their robustness to data distribution shifts.

### 4.5. Transferability of Convolution-Transformer Hybrid Pre-Trained Models

Despite the initial success of the first generation of Vision Transformers (ViT) (Dosovitskiy et al., 2021), their performance heavily depended on extensive training with curated data. To overcome this limitation, subsequent research introduced hybrid architectures, such as DeiT (Touvron et al., 2021) and CvT (Wu et al., 2021), which integrate convolutions into the ViT framework, aiming to enhance performance and robustness while maintaining computational and memory efficiency. To provide insights into the performance of these hybrid architectures compared with the modern ConvNet and vision transformer architectures, we investigate the transferability of pretrained models with hybrid architectures to medical imaging tasks. Specifically, we analyzed the transferability of CvT, DeiT, Swin, and ConvNext pretrained models across three target tasks: TXC, DXC₅, and DXC₁₄. From the results in Table 4, we draw the following observations: (1) The CvT pretrained model provides superior performance compared with the DeiT model across all tasks, in line with their ImageNet top-1 accuracy (Wu et al., 2021). (2) The CvT pretrained model outperforms the Swin model in TXC, which has a smaller amount of fine-tuning data (528 labeled data). This suggests that the annotation efficiency benefit of ConvNets transfers to the CvT model. However, in tasks with larger amounts of fine-tuning data (DXC₁₄ with 86K labeled data and DXC₅ with 224K labeled data), CvT underperforms compared with the Swin model. This highlights the advantages of hierarchical transformers over conventional vision transformers, such as CvT and DeiT, in handling large datasets. (3) While CvT lags behind ConvNext in the TXC task, the performance gap decreases as the amount of fine-tuning data increases in DXC₁₄ and DXC₅. This underscores the greater annotation efficiency of modern ConvNet models like ConvNext, while also demonstrating the potential of vision transformers to compete favorably with ConvNets when substantial data is available. In summary, our analysis indicates that the transferability advantage observed in ConvNets does not fully extend to hybrid models like CvT and DeiT. One possible reason is that hybrid models, while integrating convolutional and transformer features, may not fully exploit the advantages of convolutional layers due to their more complex architecture. This complexity might dilute the effectiveness of local feature extraction, which is crucial for medical imaging tasks. According to our bench-marking analysis in Sec. 3.1 and Sec. 3.2, we envision that hybrid models combining modern vision transformer designs, particularly hierarchical transformers, and modern ConvNets like ConvNext, may be more suitable for medical imaging tasks. Further research may explore optimizing these hybrid models to better integrate convolutional and transformer features, which, as it is out of the scope of our study, we leave as future work.

TABLE 5
We conduct ablation study with two popular segmentation decoders, namely U-Net and
UPerNet, on four medical segmentation tasks. U-Net provides significantly better
(p < 0.05) compared with UPerNet in both organ and lesion segmentation tasks.

| Segmentation | | Organ segmentation (Dice %) | | Lesion segmentation (Dice %) | |
|---|---|---|---|---|---|
| Architecture | | Clavicle | Heart | Breast cancer | Pneumothorax |
| Encoder | Decoder | segmentation | segmentation | segmentation | segmentation |
| ConvNeXt-B | UPerNet | 90.70 ± 0.75 | 95.22 ± 0.08 | 83.46 ± 1.35 | 71.45 ± 0.32 |
| | U-Net | 92.70 ± 0.11 | 95.31 ± 0.08 | 84.65 ± 0.62 | 71.99 ± 0.27 |

To dissect the impact of various segmentation decoders in medical image segmentation tasks, we have ablated two popular segmentation architectures, namely U-Net (Ronneberger et al., 2015) and UPerNet (Xiao et al., 2018). The U-Net follows a symmetric architecture with an encoder-decoder structure. The decoder consists of a series of upsampling layers followed by convolutional layers. Each stage in the decoder involves up-sampling the feature map, followed by a 2×2 convolution that halves the number of feature channels. Each upsampling layer is followed by concatenation with features from the corresponding encoder layers, and then two 3×3 convolutions, each followed by a ReLU activation. The final layer is a 1×1 convolutional layer that maps to the desired number of output classes, often followed by a softmax or sigmoid activation. The UPerNet decoder builds upon a Pyramid Pooling Module (PPM)

### 4.6. Benchmarking Segmentation Architectures

To dissect the impact of various segmentation decoders in medical image segmentation tasks, we have ablated two popular segmentation architectures, namely U-Net (Ronneberger et al., 2015) and UPerNet (Xiao et al., 2018). The U-Net follows a symmetric architecture with an encoder-decoder structure. The decoder consists of a series of upsampling layers followed by convolutional layers. Each stage in the decoder involves up-sampling the feature map, followed by a 2×2 convolution that halves the number of feature channels. Each upsampling layer is followed by concatenation with features from the corresponding encoder layers, and then two 3×3 convolutions, each followed by a ReLU activation. The final layer is a 1×1 convolutional layer that maps to the desired number of output classes, often followed by a softmax or sigmoid activation. The UPerNet decoder builds upon a Pyramid Pooling Module (PPM) and a Feature Pyramid Network (FPN) to handle multi-scale features. The PPM module includes multiple pooling operations at different scales (e.g., 1×1, 2×2, 3×3, 6×6) followed by 1×1 convolutions. The outputs from these pooled features are up-sampled and concatenated to form a rich feature representation. The FPN module incorporates lateral connections from different stages of the encoder, which are merged with upsampled features from the decoder. Following each upsampling, 3×3 convolutional layers with ReLU activations are applied to refine the features. The final layer of the UPerNet decoder is a 1×1 convolutional layer that produces the final segmentation map, followed by a softmax or sigmoid activation.

To explore the effect of the segmentation decoders, we fixed other influencing factors, including the encoder architecture and encoder initialization. Specifically, we used pretrained ConvNext-B as the encoder, given its superior performance across tasks during our benchmarking, and coupled it with both U-Net and UPerNet decoders. Each model (ConvNext-B with U-Net and ConvNext-B with UPerNet) was evaluated on four medical segmentation tasks: organ segmentation (heart and clavicle) and lesion segmentation (breast cancer and pneumothorax). As seen in Table 5, ConvNext-B with U-Net outperforms ConvNext-B with UPerNet across all the tasks under study. This could be attributed to the design of U-Net, which is specifically tailored for medical tasks to capture nuanced details from medical images.

Considering the existence of diverse segmentation architectures, such as U-Net, UPerNet, U-Net++ (Zhou et al., 2018), and DeepLabV3 (Chen et al., 2017), that can be coupled with different encoders, including various variants of ConvNet and vision transformers, a large-scale benchmarking study for in-depth exploration of these architectures on diverse medical segmentation tasks is needed, which falls outside the scope of our current study. We believe our findings in this bench-marking study on the transferability of various new pretraining techniques in medical imaging can significantly benefit future benchmarking, particularly benchmarking segmentation architectures in medical imaging. By dissecting various pretrained models in medical imaging, our work's findings can reduce the number of encoder settings that future researchers need to consider. This streamlining allows subsequent studies to focus more efficiently and effectively on exploring different segmentation decoders, building on our results to complete the next phase of benchmarking with fewer experiments. We hope our benchmarking not only accelerates the research process but also reduces the need for extensive computational resources.

TABLE 6
Comparison of the transferability of self-supervised methods (i.e.,
SwAY and MoCo-v2) pretrained on fine-grained data (i.e., iNat2021
dataset) and coarse-grained data (ImageNet-1K dataset). The table
shows the fine-tuning performance of SwAY and MoCo-v2 models
on three different target tasks: thoracic disease classification
(DXC₂₄), tuberculosis classification (TXC), and pneumothorax
segmentation (PXS). As seen, regardless of the pretraining data (either
ImageNet or iNat2021), SwAY consistently outperforms MoCo-v2
across all tasks, demonstrating the importance of SSL pretext task
design in learning generalizable representations. Additionally,
both SwAY and MoCo-v2 models pretrained on the ImageNet
dataset outperform their counterparts pretrained on the iNat2021
dataset, highlighting the importance of input data diversity
in the self-supervised learning paradigm.

| | | Downstream Tasks | | |
|---|---|---|---|---|
| | | Thoracic disease | Tuberculosis | Pnemothorax |
| SSL | Pretraining | classification | classification | segmentation |
| Method | dataset | (AUC %) | (AUC %) | (Dice %) |
| MoCo-v2 | iNat2021 | 80.34 ± 0.17 | 94.9 ± 1.61 | 66.74 ± 1.11 |
| | ImageNet | 80.46 ± 0.54 | 95.57 ± 0.90 | 67.01 ± 1.28 |
| SwAV | iNat2021 | 81.32 ± 0.08 | 94.94 ± 0.45 | 69.83 ± 0.70 |
| | ImageNet | 81.93 ± 0.18 | 95.72 ± 0.50 | 70.44 ± 0.75 |

### 4.7. Impact of Pretext Task Design and Pretraining Data Granularity on the Transferability of Self-Supervised Learning Models

In contrast to supervised learning, which requires labeled data for training a model, the self-supervised learning (SSL) paradigm only requires the data itself for training. Therefore, a model trained in a self-supervised manner cannot be aware of the granularity of input labels, whether fine-grained or coarse-grained, as it does not use them during the pretraining stage. We hypothesize that in the SSL paradigm, the design of pretext tasks is crucial for unlocking the underlying structure of data to learn more transferable representations. To test this hypothesis, we compared the transferability of self-supervised methods pretrained on fine-grained data (i.e., the iNat2021 dataset—the most recent large-scale fine-grained dataset) and coarse-grained data (ImageNet-1K—which was created for coarse-grained object classification). We fine-tuned existing official and publicly available pretrained models of SwAV and MoCo-v2 that were pretrained on iNat2021 and ImageNet-1K datasets for different target tasks: thoracic disease classification (DXC₁₄), tuberculosis classification TXC), and pneumothorax segmentation (PXS).

As seen in Table 6, regardless of the pretraining data (either ImageNet or iNat2021), SwAV consistently outperforms MoCo-v2 across all tasks, demonstrating the importance of SSL pretext task design and their learning objectives, echoing our observations in Sec. 3.4. Furthermore, both SwAV and MoCo-v2 models pretrained on the ImageNet dataset outperform their counterparts pretrained on the iNat2021 dataset, highlighting the importance of input data diversity, which is higher in the ImageNet dataset compared with iNat2021. We would like to clarify that in this study, we used existing official and ready-to-use pretrained models, ensuring that their configurations have been meticulously assembled to achieve the best results in the target tasks. However, the lack of publicly available SSL pretrained models that leverage fine-grained datasets, such as iNat2021, during the pretraining stage hinders us from benchmarking them comprehensively in this study, which remains as future work.

### 4.8. High-Performance and Computationally Intensive Models

The landscape of deep learning has been profoundly transformed by the advent of advanced computing resources like GPUs and TPUs. This shift has rendered the once-daunting task of training deep models remarkably efficient, thus diminishing the relevance of computational constraints. Today, the emphasis in Al research has decisively moved towards achieving the highest possible performance, as exemplified by cutting-edge models such as DALLE-2, ChatGPT, and Llama. These advancements underscore the notion that the computational intensity required for high-performance models is no longer a bottleneck but a manageable aspect of the model development process.

TABLE 7
Comparison of the number of training epochs required by
ConvNext and Swin models for different target tasks.

| | # Training Epochs in Downstream Tasks | | | | | | |
|---|---|---|---|---|---|---|---|
| | | 14 thoracic | | | | Breast | |
| | Tuberculosis | disease | Heart | Clavicle | Pneumothorax | cancer | Lung |
| | classi- | classi- | segmen- | segmen- | segmen- | segmen- | segmen- |
| Backbone | fication | fication | tation | tation | tation | tation | tation |
| Swin-T | 59.8 | 105.2 | 151.8 | 250.9 | 64.1 | 140.0 | 217.5 |
| ConvNeXt-T | 18.8 | 7.0 | 134.8 | 198.6 | 53.3 | 120.3 | 179.2 |
| Swin-B | 60.4 | 36.0 | 128.7 | 258.0 | 61.9 | 97.4 | 229.0 |
| ConvNeXt-B | 20.0 | 4.0 | 140.8 | 198.6 | 55.4 | 100.0 | 191.7 |

For a comprehensive analysis, we systematically examined the computational requirements of vision transformers and ConvNet models in our benchmarking study. To do so, we compared variants of different architectures with a compatible number of parameters, creating two groups of comparable models: (1) ConvNext-T and Swin-T, and (2) ConvNeXt-B and Swin-B. We assessed the number of training epochs required for each of these models across several downstream tasks. As shown in Table 7, ConvNext models generally require fewer training epochs than their Swin counterparts. Specifically, ConvNext-T requires fewer training epochs than Swin-T across all downstream tasks. ConvNext-B shows superiority in terms of training epochs in CXS, DXC₁₄, LXS, PXS, and TXC, while Swin-B demonstrates superiority in BUS and HXS. According to this analysis, ConvNeXt variants compared to Swin variants indicate a slight edge in computational efficiency. However, the average difference in the number of training epochs in each group—39 fewer epochs for ConvNext-T than Swin-T and 27 fewer epochs for ConvNext-B than Swin-B—are not dramatically substantial.

In summary, powerful computing has liberated researchers to pursue excellence in model performance, marking a pivotal evolution in AI research and application. Therefore, the primary focus can rightfully be on optimizing model architectures and refining training methodologies to push the boundaries of performance. While it remains crucial to consider environmental impacts such as CO2 emissions and heat generation associated with intensive computing, these aspects, though significant, extend beyond the scope of our current investigation.

### 4.9. Practical Utility for Clinical Settings

In this research study, we have primarily focused on medical imaging and the application of artificial intelligence (AI) in this domain. AI in medicine is still in its early stages, and while our research provides valuable insights, these findings may be context-specific and may not be universally applicable without further validation. The results presented in our paper are part of a larger research context. Due to the empirical and observational nature of our research study, there are inherent limitations in generalizing the findings. Our work covers a diverse range of modalities and tasks, but it is crucial to understand that these insights are derived from controlled experimental conditions and may not directly translate to real-world clinical environments. To ensure the practical utility and reliability of the tools and models developed in our study, comprehensive evaluations in real-world clinical settings are essential. Any commercial deployment of these AI models should be approached with caution. Proper FDA and other regulatory approvals must be obtained to guarantee their appropriate and safe use. This validation process is critical to mitigate potential risks and confirm that the models perform reliably in various clinical scenarios. The practical application of AI models in medicine requires thorough clinical validation and strict adherence to regulatory compliance. This discussion highlights the importance of ongoing research and continuous evaluation to bridge the gap between empirical findings and their implementation in clinical practice. Only through rigorous validation can AI tools achieve practical utility. In conclusion, while our study advances the understanding of AI applications in medical imaging, it is imperative to recognize the limitations and the need for further validation, which will enhance the applicability and reliability of AI models in diverse clinical settings.

### 4.10. Study Scope and Future Directions

Our study focuses on transfer learning, specifically the fine-tuning of models pretrained on photographic images for medical image analysis. Given the limited availability of labeled medical data, transfer learning is essential for developing per-formant deep models for medical imaging applications. We conducted approximately 5,000 experiments utilizing 53 pre-trained models across 14 medical imaging tasks. These tasks encompassed various label structures (binary classification, multi-label classification, and segmentation), imaging modalities (X-ray, CT, Fundoscopic, and Ultrasound), organs (lung, heart, clavicle, ribs, eye, and breast), diseases, and data sizes. This broad scope demonstrates the extensive nature of our work and highlights the practical challenges associated with managing an exponential increase in experiments if the scope were not controlled. To address practical feasibility, we focused on four imaging modalities: X-ray, CT, Fundoscopic, and Ultrasound. Chest radiographs (CXRs) were specifically emphasized due to their widespread use and the substantial availability of CXR datasets in the research community. The focus on CXRs reflects the need for robust models tailored to this modality, given its critical role in medical diagnostics. Moreover, the availability of large-scale CXR datasets makes it feasible to conduct extensive experiments with varying data fractions, ranging from small to massive, to derive valuable insights. By concentrating on these modalities, we aimed to balance comprehensive coverage with practical constraints, effectively addressing the pressing need for effective CXR models. While our study encompasses a diverse range of modalities and tasks, there are inherent limitations to the generalizability of our results. Extending our research to include additional modalities and specific diagnostic tasks, such as fracture detection in X-rays or tumor identification in MRIs, could offer further valuable insights. Future research directions should focus on exploring the generalizability of transfer learning across different medical imaging contexts, enhancing our understanding and application of these techniques.

### 5. Our Related Work

We previously conducted a pioneering benchmarking study, evaluating a variety of pretraining techniques for medical imaging tasks, addressing central and timely questions on transfer learning in medical image analysis. This paper substantially expands upon the preliminary version and incorporates the following notable enhancements:
1. We have extended our transfer learning evaluations to 14 medical applications, expanding the comprehensiveness of our findings across distribution shifts, diseases, organs, and modalities.
2. We have examined pretrained models with 12 conventional and modern vision transformer and ConvNet backbones, dissecting their transferability to medical applications.
3. We have conducted extensive experiments to investigate the impact of fine-tuning data size on the performance of vision transformers compared with ConvNets, exploring their annotation efficiency for medical applications.
4. We have evaluated four fine-grained datasets (iNat2021, ImageNet-22K, Places365, COCO), exploring the advantages of utilizing large-scale fine-grained datasets for transfer learning to medical applications.
5. We have expanded our benchmarking to 22 recent SOTA self-supervised ImageNet models, studying their generalizability to medical applications compared with supervised ImageNet models.
6. We have conducted extensive experiments to analyze the effectiveness of our domain-adaptive pretraining technique by including vision transformers and recent SOTA ConvNets as well as utilizing larger in-domain datasets, demonstrating the effectiveness of our approach in tailoring ImageNet models for medical applications.
7. We have assessed the efficacy of pretraining with the RadImageNet dataset compared with the ImageNet dataset for transfer learning in various medical applications.
8. We have investigated the effectiveness of in-domain self-supervised learning compared with in-domain supervised learning across a range of medical applications.
9. We have explored the transferability of self-supervised pretrained models using in-domain versus out-domain data.
10. We have evaluated the performance of various pretrained ConvNet and vision transformer models under stress testing, providing deeper insights into their generalizability and robustness on out-of-distribution data.
11. We have explored the transferability of convolution-transformer hybrid pretrained models compared with modern ConvNet and vision transformers across different tasks.
12. We have conducted ablation studies on different segmentation architectures and discussed directions for future benchmarks on segmentation architectures in medical image analysis.
13. We have conducted ablation studies to investigate the impact of pretext task design and data granularity on the transferability of self-supervised learning models across a range of downstream tasks.
14. We have expanded our benchmarking analysis to include an evaluation of the computational requirements for different downstream task using vision transformer and ConvNet models, an discussed the trade-off between high-performance but computationally intensive models.
15. We have included discussion on the directions for future work and the practical utility of our findings for clinical settings.
16. We have provided the details of our statistical analysis and a systematic evaluation as proof of concept to demonstrate its efficacy.

### 6. Conclusion

We provide a fine-grained and up-to-date study on the transferability of various brand-new pretraining techniques for medical imaging tasks, answering central and timely questions on transfer learning in medical image analysis. We summarize the key findings from our broad systematic study (˜5,000 experiments) as follows:
1. ConvNext variants compete favorably against their Swin counterparts in both transfer learning and in training from scratch settings, emphasizing the continued relevance and effectiveness of ConvNets in medical imaging.
2. ConvNets exhibit greater annotation efficiency than vision transformers when fine-tuned for medical imaging tasks, yet vision transformers have the potential to surpass ConvNets when substantial data is available for fine-tuning.
3. Fine-grained pretrained models outperform the coarse-grained supervised ImageNet model, offering a viable alternative for transfer learning in fine-grained medical tasks.
4. Self-supervised learning approaches excel in capturing holistic features effectively, leading to higher transferability compared with supervised approaches across diverse medical imaging tasks.
5. Our proposed domain adaptive pretraining approach can harness knowledge acquired from ImageNet and enhance it by utilization of readily accessible expert annotations associated with medical datasets, leading to the development of more performant models with domain-relevant information in their learned embeddings. In closing, we hope that this large-scale open evaluation of transfer learning can direct the future research of deep learning for medical imaging.

### Appendices

### A. Statistical Analysis Details

In this study, we employed a one-tailed Welch's t-test to conduct statistical significance analysis. A one-tailed test was chosen because we had a specific directional hypothesis (i.e., Model A's mean is greater than Model B's mean in a task). Welch's t-test was selected because it does not assume equal variances between groups, making it more robust and reliable in the presence of heteroscedasticity (unequal variances). Additionally, it helps to reduce the potential for Type I errors, as Welch's t-test is more conservative than the standard t-test (Derrick et al., 2016; Ergin and Koskan, 2023).

To ensure the appropriateness of using t-tests, in Table 8, as a proof of concept, we provide a systematic analysis by presenting the detailed results of ConvNext-B and Swin-B in three different tasks: heart segmentation, pneumothorax segmentation, and breast cancer segmentation. In addition to the performance of all 10 runs of each model in each task, we have reported the following:
The average±standard deviation.
Shapiro-Wilk test results to demonstrate that the performance for each model in each task follows a normal distribution.
F-test results to show whether the two independent samples have equal or unequal variances.
Standard t-test results to demonstrate the robustness and conservativeness of Welch's t-test in the presence of homoscedasticity.
The results of our one-tailed Welch's t-test to show statistical significance analysis in each task between the ConvNext-B and Swin-B models.
Mann-Whitney U test results, which serve as a failsafe option to t-test, further demonstrating the validity of our t-test analysis in assessing statistical significance.

As seen in Table 8, according to the Shapiro-Wilk test results, the performance results for each model in each task follow a normal distribution (p-value>0.05). Additionally, given that each model was run 10 times independently on each task, both required conditions (i.e., two independent samples and normally distributed data) (Manfei et al., 2017) for conducting t-tests have been met. Moreover, according to the F-test results, in the heart segmentation task, the two models have unequal variances (p-value<0.05), which necessitates using Welch's t-test. However, in the pneumothorax and breast cancer segmentation tasks, the two models have equal variances (p-value>0.05). Even in these cases, Welch's t-test provides a higher p-value compared to the standard t-test, demonstrating the robustness of Welch's t-test to variances equality and reducing the potential for Type I errors. Additionally, according to the Mann-Whitney U Test, which we considered as an alternative statistical methodology to our t-test, the results corroborate the findings from our one-tailed Welch's t-test, providing further confidence in the robustness and validity of our analysis.

### B. Performance of ConvNeXt and Swin Variants Using Different Metrics

We have expanded our analysis to include the Intersection over Union (IoU) metric, in addition to Dice, for clavicle segmentation and pneumothorax segmentation tasks. This was done to ensure that our observations in Sec. 3.2—that ConvNets are more annotation efficient than vision transformers—holds true regardless of the performance metrics used for evaluation. As shown in Table 9, in the clavicle segmentation task, the difference in performance between ConvNext-T and Swin-T is 3.7 and 3.4 percentage points when using Dice and IoU metrics, respectively. Similarly, the difference between ConvNext-B and Swin-B in this task is 3.8 and 3.4 percentage points for Dice and IoU, respectively. In the pneumothorax segmentation task, ConvNext-T outperforms Swin-T by 1 percentage point in Dice and 2.5 percentage points in IoU. Likewise, ConvNext-B shows an improvement over Swin-B by 1.2 percentage points in Dice and 1.5 percentage points in IoU. These consistent performance gains across different metrics reinforce our assertion that ConvNets are indeed more annotation efficient than vision transformers.

### C. Datasets and Tasks

ImageNet (Russakovsky et al., 2015): The ImageNet dataset was originally introduced for the ILSVRC2012 visual recognition challenge. ImageNet has played a pivotal role in driving modern advancements in deep learning. The full dataset, referred to as ImageNet-22K dataset, comprises approximately 14M images, categorized into 21,841 classes. ImageNet-1K is a subset of the full ImageNet dataset and is composed of 1.3M images, representing 1000 exclusive classes. Due to the scale, diversity, and high-quality annotations, ImageNet-1K serves as the primary dataset for pretraining models to facilitate transfer learning across various domains. On the other hand, the ImageNet-22K dataset is less commonly employed for pretraining due to its complexity and limited accessibility. In our study, we assess the effectiveness of transfer learning for medical imaging by leveraging models pretrained on both the ImageNet-1K and ImageNet-22K datasets.

iNat2021 (Horn et al., 2021): The iNaturalist2021 (i.e., iNat2021) is a recent large-scale, fine-grained natural world image collection, including 2.7M training images that represent 10K species. The dataset comprises 11 iconic groups, with each group containing fine-grained species categories, making it well-suited for fine-grained visual classification challenges. In our study, we assess the efficacy of iNat2021 as a pretraining source for fine-grained medical tasks by utilizing the officially released pretrained model for the dataset.

COCO (Lin et al., 2014): Common Objects in Context (i.e., Microsoft COCO) is a large-scale object detection, segmentation, and captioning dataset. The dataset contains 328,000 images with 91 common object categories as well as 2,500,000 labeled instances. Compared with the popular ImageNet dataset, COCO has fewer categories but a greater number of instances per category. This attribute supports the learning of detailed object models with the capability for precise localization. In our study, we assess the efficacy of COCO as a pretraining source for medical tasks by utilizing the officially released PyTorch pretrained model for the instance segmentation task.

Places365 (Zhou et al., 2017): Places is a collection of 10 million scene photographs, labeled with 434 scene semantic categories. Places365, also referred to as Places365-Standard, is a subset of this comprehensive dataset, encompassing 1,803,460 training images spanning 365 categories. In contrast to the ImageNet dataset, in Places365, images of different scene categories may share similar appearances and objects. This unique characteristic enhances the complexity of the scene recognition task, necessitating a heightened attention of the deep models to capturing fine-grained details. In our study, we assess the efficacy of Places365 as a pretraining source for medical tasks by utilizing the officially released pretrained model for the dataset.

TABLE 8
One-tailed Welch's t-test has been used for conducting statistical significance analysis. A one-tailed
test was chosen because of a specific directional hypothesis (i.e., Model A's mean is greater than
Model B's mean in a task). Welch's t-test was selected because it does not assume equal variances
between groups, making it more robust and reliable in the presence of heteroscedasticity (unequal variances).
Additionally, it helps to reduce the potential for Type I errors, as Welch's t-test is more conservative
than the standard t-test (Derrick et al., 2016; Ergin and Koskan, 2023). As seen, according to the Shapiro-
Wilk test results, the performance results for each model in each task follow a normal distribution (p
- value > 0.05). Additionally, given that each model was run 10 times independently on each task,
both required conditions (i.e., two independent samples and normally distributed data) (Manfei et al.,
2017) for conducting t-tests have been met. According to the F-test results, in the heart segmentation
task, the two models have unequal variances (p - value < 0.05), which necessitates using Welch's
t-test. However, in the pneumothorax and breast cancer segmentation tasks, the two models have equal
variances (p - value > 0.05). Even in these cases, Welch's t-test provides a higher p - value
compared with the standard t-test, demonstrating the robustness of Welch's t-test to variances equality
and reducing the potential for Type I errors. According to the Mann-Whitney U Test, which we considered
as an alternative statistical methodology to our t-test, the results corroborate the findings from our
one-tailed Welch's t-test, providing further confidence in the robustness and validity of our statistical
analysis. In all tests, the significance level (α) is 0.05.

| | Heart | | Pneumothorax | | Breast cancer | |
|---|---|---|---|---|---|---|
| | segmentation | | segmentation | | segmentation | |
| | (Dice %) | | (Dice %) | | (Dice %) | |
| Trials | ConvNext-B | Swin-B | ConvNext-B | Swin-B | ConvNext-B | Swin-B |
| Run 1 | 95.11 | 93.95 | 71.07 | 70.10 | 81.48 | 79.36 |
| Run 2 | 95.25 | 94.54 | 71.23 | 70.47 | 81.87 | 81.74 |
| Run 3 | 95.30 | 94.66 | 71.86 | 69.38 | 85.16 | 80.76 |
| Run 4 | 95.18 | 94.46 | 71.43 | 70.96 | 83.97 | 80.47 |
| Run 5 | 95.23 | 94.59 | 71.72 | 70.28 | 84.55 | 82.02 |
| Run 6 | 95.21 | 94.23 | 71.48 | 71.11 | 82.23 | 81.23 |
| Run 7 | 95.16 | 94.68 | 71.57 | 70.50 | 83.79 | 81.00 |
| Run 8 | 95.37 | 94.34 | 71.60 | 69.78 | 82.80 | 79.97 |
| Run 9 | 95.30 | 94.32 | 70.82 | 69.51 | 85.34 | 82.65 |
| Run 10 | 95.13 | 94.82 | 71.71 | 70.10 | 83.45 | 81.63 |
| Average ± STD | 95.22 ± 0.08 | 94.46 ± 0.26 | 71.45 ± 0.32 | 70.22 ± 0.57 | 83.46 ± 1.35 | 81.08 ± 0.99 |
| Shapiro-Wilk test | 0.939 | 0.909 | 0.580 | 0.885 | 0.760 | 1 |

| | | | |
|---|---|---|---|
| F test | 0.00249 | 0.106 | 0.367 |
| Welch's t-test | 0.000001143 | 0.00001668 | 0.0001681 |
| (used in our study) | | | |
| Standard t-test | N/A | 0.0000063 | 0.0001375 |
| Mann Whitney U test | 0.00009083 | 0.0002187 | 0.0002436 |

Breast Ultrasound (Al-Dhabyani et al., 2020): The dataset comprises 780 breast ultrasound images obtained from 600 female patients aged between 25 and 75 years. These images are classified into three categories: normal, benign, and malignant. Additionally, the dataset includes pixel-level segmentation masks for cases of breast cancer. We randomly divide the data into training (80%) and test (20%), and report the mean Dice score for the breast cancer segmentation task.

TABLE 9
Performance differences between ConvNeXt and Swin variants for
clavicle and pneumothorax segmentation tasks using Dice and IoU
metrics. The results demonstrate that ConvNeXt variants consistently
outperform Swin variants across both metrics. This reinforces
the annotation efficiency of ConvNets over vision transformers
regardless of the performance metrics used for evaluation.

| | ConvNeXt-T | | ConvNeXt-B | |
|---|---|---|---|---|
| | versus Swin-T | | versus Swin-B | |
| | Dice | IoU | Dice | IoU |
| Downstream | Difference | Difference | Difference | Difference |
| Tasks | (%) | (%) | (%) | (%) |
| Clavicle | 3.7 | 3.4 | 3.8 | 3.4 |
| segmentation | | | | |
| Pneumothorax | 1.0 | 2.5 | 1.2 | 1.5 |
| segmentation | | | | |

SCR-Heart&Clavicle (van Ginneken et al., 2006): The dataset provides 247 posterior-anterior chest radiographs from JSRT database along with segmentation masks for the heart, lungs, and clavicles. The data has been subdivided into two folds with 124 and 123 images. We follow the official split of the dataset, using fold1 for training (124 images) and fold2 for testing (123 images). We use the mean Dice score to evaluate the heart and clavicles segmentation performances.

CheXpert (Irvin et al., 2019): The CheXpert is a large-scale dataset consisting of 224,316 multiview chest radiographs taken from 65,240 patients. The training images were annotated by a labeler to automatically detect the presence of 14 thorax diseases in radiology reports, capturing uncertainties inherent in radiograph reports by using an uncertainty label. The test set consists of 234 images from 200 patients. The test images were manually annotated by board-certified radiologists for 5 selected diseases. In our study, we utilize the CheXpert dataset as both a pretraining source as well as a target dataset. We use the official data split and report the mean AUC score over 5 test diseases for the multi-label chest X-ray classification task.

VinDR-CXR (Nguyen and et al., 2020): The dataset contains 18,000 posterior-anterior chest radiographs, along with image-level labels provided by expert radiologists for 6 conditions: lung tumor, pneumonia, tuberculosis, other diseases, COPD, and No finding. We use the official data split, which includes 15,000 images for training and 3,000 for testing, and report the mean AUC score over 6 diseases for the multi-label chest X-ray classification task.

MIMIC-CXR (Johnson et al., 2019): MIMIC-CXR is a large-scale publicly available dataset containing chest radiographs with corresponding radiological reports. The dataset contains 377,110 images corresponding to 227,835 radiographic studies. The dataset provides image-level labels for 13 thoracic diseases, where the labels derived from radiology reports using two open source labeler tools, namely NegBio and CheX-pert labelers. The dataset includes an official split, dividing images into training, validation, and test sets, comprising 368,945, 2,991, and 5,159 images, respectively. In our study, we utilize the MIMIC-CXR dataset as both a pretraining source as well as a target dataset. We use the official data split provided by the dataset, and report the mean AUC score over 13 diseases for the multi-label chest X-ray classification task.

ChestX-ray14 (Wang et al., 2017): The NIH ChestX-ray14 dataset is a hospital-scale dataset, comprising 112,120 frontal view X-ray images of 32,717 unique patients. The labels for 14 common thoracic pathologies are extracted from the chest X-ray radiological reports using natural language processing techniques, where each individual image may have more than one label. The dataset provides an official patient-wise split for training (86K images) and test (25K images) sets. In our study, we utilize the ChestX-ray14 dataset both as a pretraining source and as a target dataset. We use the official data split and report the mean AUC score over 14 diseases for the multi-label chest X-ray classification task.

ChestX-Det: (Lian et al., 2021): The dataset includes 3,578 chest X-ray images along with pixel-level segmentation masks for 13 common thoracic conditions, including atelectasis, calcification, cardiomegaly, consolidation, diffuse nodule, effusion, emphysema, fibrosis, fracture, mass, nodule, pleural thickening, and pneumothorax. We use the official dataset split, comprising 3,025 images for training and 553 images for testing, and report the intersection over union (IoU) for the disease segmentation task.

RSNA PE Detection (Colak et al., 2021): This dataset includes 7,279 CTPA scans with a varying number of images in each scan. This dataset contains annotations at both slice and exam levels. Each individual image slice is annotated to indicate the presence or absence of a pulmonary embolism (PE). Additionally, each patient's scan has been annotated for nine additional labels. We randomly split the data at patient-level, resulting in training and testing sets with 6,279 and 1,000 scans, respectively. We use slice-level annotations for predicting the presence or absence of PE, and use the AUC score to measure the accuracy of the PE detection task.

NIH Montgomery (Jaeger et al., 2014): The dataset contains 138 frontal-view chest X-rays from Montgomery County's Tuberculosis screening program, of which 80 are normal cases and 58 are cases with manifestations of TB. The segmentation masks for left and right lungs are provided. We randomly divided the dataset into a training set (80%) and a test set (20%) and report the mean Dice score for the lung segmentation task.

SIIM-ACR (Zawacki et al., 2019): The Society for Imaging Informatics in Medicine (SIIM) and American College of Radiology provided the SIIM-ACR Pneumothorax Segmentation dataset, consisting of 10K chest X-ray images and the segmentation masks for Pneumothorax disease. We randomly divided the dataset into training (80%) and testing (20%), and the segmentation performance was evaluated by using the Dice coefficient score.

VinDr-Rib (Nguyen et al., 2021): The dataset contains 245 chest radiographs accompanied by pixel-level segmentation masks for 20 individual anterior and posterior ribs (10 on each side of the lungs). We utilize the official dataset split, which includes 196 images for training and 49 for testing. We report the mean Dice score for the ribs segmentation task.

NIH Shenzhen CXR (Jaeger et al., 2014): The dataset contains 662 frontal-view chest X-rays, of which 326 are normal cases and 336 are cases with manifestations of Tuberculosis (TB). We randomly divide the dataset into a training set (80%) and a test set (20%). We report the AUC score for the Tuberculosis detection task.

DRIVE (Budai et al., 2013): The dataset contains 40 retinal images, separated by its providers into a training set (20 images) and a test set (20 images). For all images, manual segmentation of the vasculature is provided. We use the official data split and report the mean Dice score for the segmentation of blood vessels.

### D. Implementation Details

Since different datasets require different optimal settings, we strive to optimize each target task with the best performing hyperparameters. For all target tasks, we employ standard data augmentation techniques including (i) random cropping, horizontal flipping, and rotating for classification tasks on X-ray modality (i.e., DXC₅, DXC₁₄, DXC₁₃, and TXC), (ii) random contrast, cutout, and translation, scaling, and rotation for classification task on CT modality (i.e. ECC); (iii) Random BrightnessContrast, RandomGamma, OpticalDistortion, elastic transformation, and grid distortion for segmentation tasks on X-ray (i.e., PXS, CXS, LXS, and HXS) and Ultrasound (i.e. BUS) modalities, and (iv) random rotation, Gaussian noise, color jittering, as well as horizontal, vertical, and diagonal flips for the segmentation task on fundoscopic modality (i.e. VFS). In all classification tasks, we use Adam optimizer with a learning rate of 2e-4 and 4e-4 for the target tasks in X-ray and CT modalities, respectively. For the segmentation tasks, we use Adam optimizer with learning rate 1e-3. Moreover, for DeiT, Swin, and ConvNext backbones we follow (Liu et al., 2021; Matsoukas et al., 2022; Liu et al., 2022) in using AdamW optimizer, and employ a learning rate 2e-4 for all the segmentation tasks. For classification and segmentation tasks, we use the standard cross-entropy and Dice loss functions, respectively, to optimize the target models for their respective tasks.

### E. Self-Supervised Learning

In this section, we provide a summary of the self-supervised learning approaches under the study.

InsDis (Wu et al., 2018) is established on the instance discrimination pretext task. In this approach, each image is treated as a separate class, and a non-parametric classifier is trained to differentiate between these individual classes using the noise-contrastive estimation (NCE) objective function (Gutmann and Hyvärinen, 2010). Additionally, InsDis introduces a feature memory bank that stores a substantial number of noise samples, referred to as negative samples, to minimize the need for exhaustive feature computation.

MoCo-v1 (He et al., 2020) and MoCo-v2 (Chen et al., 2020c) are established on contrastive learning paradigm. In MoCo-v1, two views are generated by applying two independent data augmentations to the same image, which are referred to as positive samples. Furthermore, samples derived from different images are considered negative samples, and their features are stored in a memory bank. Additionally, a momentum encoder is introduced to ensure the consistency of negative samples as they evolve during training. MoCo-v1 trains the model to enhance the similarity between positive samples while reducing the similarity between negative samples. MoCo-v2 builds upon MoCo-v1 with several enhancements inspired by SimCLR-v1 (Chen et al., 2020a), including the incorporation of a non-linear projection head, additional augmentations, the use of a cosine decay schedule, and longer training compared with MoCo-v1.

PCL-v1 and PCL-v2 (Li et al., 2021) integrate contrastive learning and clustering approaches, aiming to capture the semantic structure of the data into the learned embedding space. Specifically, PCL-v1 adopts contrastive learning paradigm from MoCo, and incorporates clustering in its learning objective. To do so, PCL-v1 has self-labeling and feature-learning phases, similar to the clustering approaches. In the self-labeling phase, the features obtained from the momentum encoder are clustered, in which each instance is assigned to multiple prototypes (cluster centroids) with different granularity. In the feature-learning phase, PCL-v1 extends the noise-contrastive estimation (NCE) loss to ProtoNCE loss which pushes each sample closer to its assigned prototypes. PCL-v2 is developed by applying the aforementioned techniques to promote representation learning.

PIRL (Misra and Maaten, 2020) aims to create image representations that closely resemble the representations of transformed versions of the same image while being distinct from the representations of other images. To achieve this, PIRL employs Jigsaw and Rotation proxy tasks for generating positive samples. Specifically, these positive samples are created by applying Jigsaw shuffling or rotating images. PIRL formulates a loss function based on noise-contrastive estimation (NCE) and integrates a memory bank of negative samples, following a similar approach as InsDis. In this paper, we evaluate PIRL with Jigsaw shuffling, which has demonstrated superiority over its rotation-based counterpart.

SimCLR-v1 (Chen et al., 2020a) and SimCLR-v2 (Chen et al., 2020b) are established on contrastive learning paradigm. The SimCLR-v1 method is based on the contrastive learning paradigm, sharing similarities with MoCo. However, unlike MoCo, SimCLR-v1 doesn't rely on specific network architectures, such as a momentum encoder or a memory bank. Instead, it is trained end-to-end with large batch sizes, and negative samples are generated within each batch during training. In SimCLR-v2, the framework is further improved by enhancing the capacity of the projection head and incorporating the memory mechanism from MoCo to introduce a larger pool of negative samples compared with SimCLR-v1.

SeLa-v2 (Caron et al., 2020b) is an improved version of the SeLa (Asano et al., 2020). SeLa is a clustering-based SSL method, requiring a two-phase training (i.e., self-labeling and feature-learning). Unlike other clustering methods, which cluster image instances, SeLa formulates self-labeling as an optimal transport problem, and solves it by adopting the Sinkhorn-Knopp algorithm. The updated SeLa-v2 applies stronger data augmentation, a MLP projection head, a cosine decay schedule, and multi-cropping to improve the representation learning.

InfoMin (Tian et al., 2020) seeks to enhance contrastive learning by crafting more sophisticated data augmentations that decrease the mutual information between different views of the same image. The underlying idea behind this method is that positive samples should only share label information with respect to the downstream task while throwing away irrelevant factors, which means optimal views for contrastive representation learning are task-dependent.

BYOL (Grill et al., 2020) eliminates the need for negative samples for instance discrimination learning. To do so, BYOL employs two encoders, namely the online and target encoders, and introduces a predictor after the projector within the online encoder. The key objective in BYOL is to maximize the agreement between the predictions made by the online encoder and the features computed from the target encoder. To ensure stability during training, the target encoder is updated using a momentum mechanism, mitigating the model collapsing problem.

DeepCluster-v2 (Caron et al., 2020b) is an improved version of the DeepCluster (Caron et al., 2018) method. DeepCluster leverages a two-phase approach for representation learning. In the initial self-labeling phase, pseudo labels are generated by clustering samples and assigning cluster indexes to each sample. Subsequently, in the feature-learning phase, the cluster index for each sample is employed as a classification target for model training. These two phases are iteratively repeated until the model converges. In contrast to DeepCluster, which classifies the cluster indexes, DeepCluster-v2 minimizes the distance between each sample and its corresponding cluster centroid. Additionally, DeepCluster-v2 enhances representation learning through stronger data augmentations, the introduction of an MLP projection head, the use of a cosine decay schedule, and the adoption of multi-cropping technique.

SwAV (Caron et al., 2020b) bridges contrastive learning and clustering techniques. Similar to SeLa, SwAV computes cluster assignments (codes) for each data sample using the Sinkhorn-Knopp algorithm. However, SwAV performs online clustering via computing cluster assignments at the batch level rather than epoch level. In contrast to traditional contrastive learning methods like MoCo and SimCLR, SwAV predicts cluster codes for two different views of the same image instead of directly comparing their features. Additionally, SwAV introduces a multi-cropping strategy, which can be adopted by other methods to improve their performances.

Barlow Twins (Zbontar et al., 2021) builds upon the instance discrimination pretext task and enhances it with a novel objective function. Barlow Twins utilizes a pair of online encoders that share weight parameters and process two distinct views of the same image. The model's training objective is to minimize the difference between the cross-correlation matrix of the encoders' outputs and the identity matrix, which results in (1) maximizing the similarity between the representations of the two views, akin to the core objective of instance discrimination learning, and (2) minimizing redundancy between the components of these two representations.

DINO (Caron et al., 2021) is rooted in knowledge distillation for self-supervised representation learning. In this approach, a student network is trained to mimic the output of a teacher network for a given input. Specifically, given an image, a set of global and local crops are extracted from the image. The student processes all the crops, while the teacher network focuses solely on the global views, encouraging global-to-global and local-to-global correspondences. To ensure the stability of the teacher network, it is updated using an exponential moving average (EMA) based on the student's weights. Additionally, DINO employs techniques such as centering and sharpening on the teacher outputs to prevent model collapse.

CLSA (Wang and Qi, 2023) seeks to enhance existing contrastive learning methods by harnessing more powerful data augmentations. These augmentations encompass a random selection from a set of 14 distinct types, such as ShearX/Y, TranslateX/Y, Rotate, AutoContrast, Invert, Equalize, Solarize, Posterize, Contrast, Color, Brightness, and Sharpness. Additionally, CLSA minimizes the distribution difference between weakly and strongly augmented images over a representation bank, which supervises the retrieval of more robust query samples.

OBVW (Gidaris et al., 2021) is built on a teacher-student scheme and aims to train a model for the reconstruction of bag-of-visual-words (BoVW) representations of images. In this framework, the teacher network extracts feature maps from an image and then densely quantizes them using a visual words vocabulary. The resulting visual words are employed as the ground truth for training the student network, which focuses on reconstructing the distribution of the visual words within an image. This method conducts online training for both the teacher and student networks, while also updating the visual-words vocabulary in an online manner.

SimSiam (Chen and He, 2021) relies on instance discrimination pretext task, aiming to maximize the similarity between two augmented views of the same image using simple Siamese networks. To prevent collapse solutions, this method leverages optimization and architectural tricks, such as using a projector head and a stop-gradient operation.

VICRegL (Bardes et al., 2022b) aims to learn global and local features simultaneously. For global representation learning, VI-CRegL leverages the VICReg (Bardes et al., 2022a) loss function, which is composed of three terms, a variance, invariance, and covariance terms. For local representation learning, VI-CRegL matches feature vectors associated with regions that are spatially close within the image (i.e., location-based matching) or close in the embedding space (i.e. feature-based matching).

DenseCL (Wang et al., 2021b) expands the scope of contrastive learning from the image-level to the dense level. To achieve this, DenseCL employs a dense projection head that generates dense feature vectors from the features of the backbone network. For dense contrastive learning, the positive samples of each local feature vector are generated by extracting dense correspondence across views. This is done by matching each feature vector in one view to the most similar feature vector in another view of the same image. Moreover, negative samples are drawn from feature vectors belonging to views from distinct images. The contrastive loss is computed at both the dense and global levels, allowing for comprehensive feature learning.

DetCo (Xie et al., 2021a) is a contrastive learning framework that is particularly advantageous for instance-level detection tasks while still delivering competitive transfer accuracy in image classification. DetCo achieves this through a multi-level supervision on features from different stages of the backbone network, thereby ensuring strong discrimination at every level of pyramid features. In addition, DetCo leverages contrastive learning to establish correspondence between the global image and local patches. This approach allows for the learning of representations at both the image-level and patch-level. Consequently, the learned representations prove valuable for both object detection and image classification tasks.

PixPro (Xie et al., 2021b) applies contrastive learning at pixel-level for learning dense feature representations. In particular, each pixel in an image is treated as an individual class, and the model is trained to distinguish each pixel from others within the image. Consequently, features of the same pixels across two different views of the same image form the positive pairs, while features of different pixels serve as negative pairs. In addition to the pixel-level contrastive learning, the authors also utilized a non-contrastive objective function to learn pixel-level consistency, eliminating the need for negative pairs.

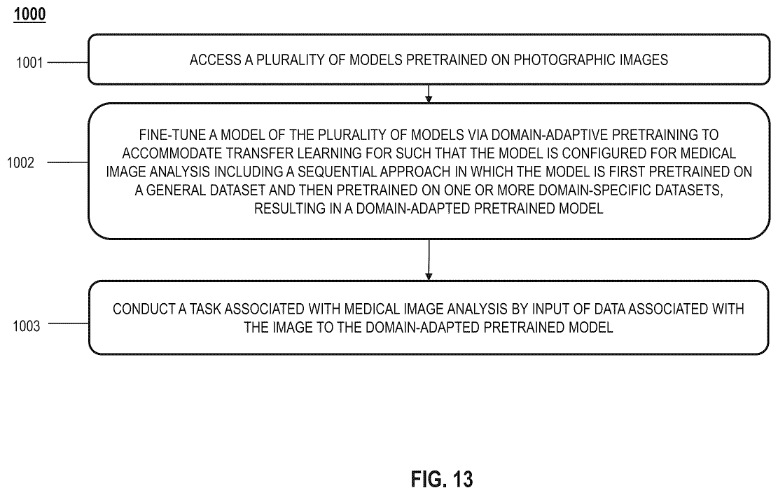

Exemplary Method/Process: Referring to FIG. 13, an example method or process is provided which can be implemented as machine readable instructions and/or via any type or number of processing elements.

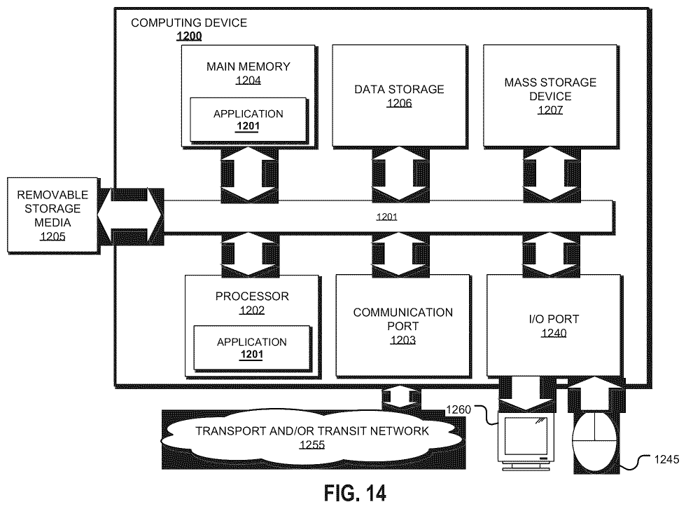

Exemplary Computing Device: Referring to FIG. 14, a computing device 1200 is illustrated which may can be configured, via one or more of an application 1211 or computer-executable instructions, to execute functionality described herein. More particularly, in some embodiments, aspects of the methods herein may be translated to software or machine-level code, which may be installed to and/or executed by the computing device 1200 such that the computing device 1200 is configured to execute functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

The described methods, processes, operations, and associated actions may also be performed in various orders in addition to the order described in this application, in parallel, and/or simultaneously. The described systems are exemplary in nature and may include additional elements and/or omit elements. Furthermore, references to or “one example” of the present disclosure are not intended to be interpreted as excluding the existence of additional embodiments that also incorporate the recited features. It will be understood that when a certain part or process “includes” a certain component or operation, that part or process does not exclude another component or operation. While illustrative examples of the name screening techniques using phonetic embeddings have been described herein including systems, devices, and the like, it is to be understood that various other adaptations and modifications may be made within the spirit and the scope of the examples herein. Additionally, it is appreciated that while specific graphics are shown and described, such graphics are illustrative and exemplary and are not intended to limit the scope of this disclosure.

The foregoing description has been directed to specific examples. It will be apparent, however, that other variations and modifications may be made to the described examples, with the attainment of some or all of their advantages. For instance, it is expressly contemplated that the components and/or elements described herein can be implemented as software being stored on a tangible (non-transitory) computer-readable medium, devices, and memories (e.g., disks/CDs/RAM/EEPROM/etc.) having program instructions executing on a computer, hardware, firmware, or a combination thereof. Further, methods describing the various functions and techniques described herein can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. In addition, devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures. Accordingly, this description is to be taken only by way of example and not to otherwise limit the scope of the examples herein. Therefore, it is the object of the appended claims to cover all such variations and modifications as come within the true spirit and scope of the examples herein.

In addition, the description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method of implementing a model for medical image analysis, comprising:
selecting a model of a plurality of models pretrained on photographic images;
tuning the model of the plurality of models via domain-adaptive pretraining to configure the model via transfer learning for medical image analysis including a sequential approach in which the model is first pretrained on a general dataset and then pretrained on one or more domain-specific datasets, resulting in a domain-adapted pretrained model; and
conducting a task associated with medical image analysis by input of data associated with an image to the domain-adapted pretrained model.

2. The method of claim 1, wherein the domain-adaptive pretraining includes:
pretraining the model on an ImageNet dataset, followed by supervised pretraining on a plurality of medical imaging datasets.

3. The method of claim 1, wherein the domain-adaptive pretraining harnesses knowledge acquired from a large-scale photographic dataset and enhances it by incorporating readily conducted annotation efforts derived from one or more distinct medical datasets of a variable size.

4. The method of claim 1, further comprising:
configuring the model for fine-grained representations, and
configuring the model to be self-supervised.

5. The method of claim 1, wherein the model being self-supervised accommodates exceled learning of holistic features leading to higher transferability compared with supervised approaches across diverse medical imaging tasks.

6. The method of claim 1, wherein the task associated with the medical image analysis includes a detection of a presence of a disease from the image.

7. The method of claim 1, further comprising:
enhancing the model by supplementing the model with expert annotations associated with medical datasets.

8. The method of claim 1, wherein the model includes SOTA vision transformer and ConvNet architectures.

9. The method of claim 1, wherein the plurality of models includes convolutional neural networks and vision transformers.

10. The method of claim 1, further comprising:
evaluating the plurality of models to select the model, by:
benchmarking the plurality of models across various medical tasks.

11. The method of claim 1, further comprising:
evaluating the plurality of models to select the model, by examining an impact of pretraining data granularity on transfer learning performance for each of the plurality of models.

12. The method of claim 1, further comprising:
evaluating the plurality of models to select the model, by investigating an impact of fine-tuning of data size.

13. The method of claim 1, further comprising:
evaluating the plurality of models to select the model, by evaluating transferability of a wide range of recent self-supervised methods with diverse training objectives to a variety of medical tasks across different modalities.

14. The method of claim 1, further comprising:
evaluating the plurality of models to select the model, by assessing efficacy of domain-adaptive pretraining on both photographic and medical datasets.

15. The method of claim 1, wherein the model is a convolution-transformer hybrid pretrained using the domain-adaptive pretraining across different tasks.

16. The method of claim 1, further comprising selecting the model by stress testing the plurality of models by application of perturbations to input images fed to the plurality of models during training and measuring the performances of the plurality of models under the study on these out-of-distribution test samples.

17. The method of claim 1, further comprising pretraining the model with fine data granularity and diverse data to yield a more fine-grained visual feature space that captures essential pixel-level cues for medical segmentation tasks.

18. The method of claim 1, further comprising training the model using self-supervised learning with diverse training objectives to a variety of medical tasks across different modalities.

19. A non-transient machine-readable medium which, when executed by a processor, causes the processor to:
select a model of a plurality of models pretrained on photographic images;
tune the model of the plurality of models via domain-adaptive pretraining to configure the model via transfer learning for medical image analysis including a sequential approach in which the model is first pretrained on a general dataset and then pretrained on one or more domain-specific datasets, resulting in a domain-adapted pretrained model; and
conduct a task associated with medical image analysis by input of data associated with an image to the domain-adapted pretrained model.

20. A method for boosting transfer learning for medical image analysis, comprising:
accessing a model of a plurality of models pretrained on photographic images; and
conducting, sequentially, domain-adaptive pretraining of the model on both photographic and medical datasets to tune the model for medical imaging tasks.
